(19) United States
(12) Patent Application Publication
(10) Pub. No.: US 2024/0340852 A1
(43) Pub. Date: Oct. 10, 2024

(54) METHOD AND APPARATUS FOR USER EQUIPMENT IN NEXT-GENERATION MOBILE COMMUNICATION SYSTEM

(71) Applicant: SAMSUNG ELECTRONICS CO., LTD., Suwon-si (KR)

(72) Inventors: Seungbeom JEONG, Suwon-si (KR); Anil AGIWAL, Santa Clara, CA (US); Jaehyuk JANG, Suwon-si (KR)

(21) Appl. No.: 18/628,621

(22) Filed: Apr. 5, 2024

Related U.S. Application Data
(60) Provisional application No. 63/494,430, filed on Apr. 5, 2023.

(30) Foreign Application Priority Data
Mar. 12, 2024 (KR) 10-2024-0034712

(51) Int. Cl. H04W 68/02; H04W 76/27; H04W 76/28

(52) U.S. Cl. CPC H04W 68/02; H04W 76/27; H04W 76/28

(57) ABSTRACT

The disclosure relates to a 5G or 6G communication system to support a data transmission rate higher than before. The disclosure provides a method performed by a user equipment (UE) in a wireless communication system. The method comprises receiving, from a base station, a UE capability request message, transmitting, to the base station, a UE capability message including first information indicating support of an extended discontinuous reception (eDRX), which is longer than 10.24 seconds, in a radio resource control (RRC) inactive, receiving, from the base station, a radio resource control (RRC) release message including paging information determined based on the first information indicating support of the eDRX longer than 10.24 seconds, and performing, based on the paging information included in the RRC release message, a paging monitoring operation in the RRC inactive.

### CROSS-REFERENCE TO RELATED APPLICATIONS

This application is based on and claims the benefit of U.S. Provisional Patent Application No. 63/494,430, filed on Apr. 5, 2023, and claims priority under 35 U.S.C. § 119 to Korean Patent Application No. 10-2024-0034712 filed on Mar. 12, 2024, in the Korean Intellectual Property Office, the disclosures of which are herein incorporated by reference in their entirety.

### BACKGROUND

### 1. Field

The disclosure relates to operation methods of a user equipment (UE) and a base station in a next generation mobile communication system. In addition, the disclosure relates to a UE and a base station in the next generation mobile communication system.

### 2. Description of Related Art

Fifth generation (5G) mobile communication technologies define broad frequency bands such that high transmission rates and new services are possible, and can be implemented not only in “Sub 6 gigahertz (GHz)” bands such as 3.5 GHz, but also in “Above 6 GHz” bands referred to as millimeter wave (mmWave) including 28 GHz and 39 GHz. In addition, it has been considered to implement sixth generation (6G) mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (cMBB), Ultra Reliable Low Latency Communications (URLLC), and massive Machine-Type Communications (mMTC), there has been ongoing standardization regarding beamforming and massive multi input multi output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, new radio (NR) user equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

The subject matter of embodiments of the disclosure is to provide a method for an improved operation of a user equipment (UE) having reduced capability.

According to an embodiment of the disclosure a method performed by a user equipment (UE) in a wireless communication system is provided. The method provides receiving, from a base station, a UE capability request message, transmitting, to the base station, a UE capability message including first information indicating support of an extended discontinuous reception (eDRX), which is longer than 10.24 seconds, in a radio resource control (RRC) inactive, receiving, from the base station, a radio resource control (RRC) release message including paging information determined based on the first information indicating support of the eDRX longer than 10.24 seconds and performing, based on the paging information included in the RRC release message, a paging monitoring operation in the RRC inactive.

According to an embodiment of the disclosure, a method performed by a base station in a wireless communication system is provided. The method comprises transmitting, to a user equipment (UE), a UE capability request message, receiving, from the UE, a UE capability message including first information indicating support of an extended discontinuous reception (eDRX), which is longer than 10.24 seconds, in a radio resource control (RRC) inactive and transmitting, to the UE, a radio resource control (RRC) release message including paging information determined based on the first information indicating support of the eDRX longer than 10.24 seconds, wherein, based on the paging information included in the RRC release message, a paging monitoring operation is performed in the RRC inactive.

According to an embodiment of the disclosure, a UE comprising a transceiver and a controller is provided. The controller is configured to receive, from a base station, a UE capability request message, transmit, to the base station, a UE capability message including first information indicating support of an extended discontinuous reception (eDRX), which is longer than 10.24 seconds, in a radio resource control (RRC) inactive.
receive, from the base station, a radio resource control (RRC) release message including paging information determined based on the first information indicating support of the eDRX longer than 10.24 seconds, and perform, based on the paging information included in the RRC release message, a paging monitoring operation in the RRC inactive.

According to an embodiment of the disclosure, a base station comprising a transceiver and a controller is provided. The controller is configured to transmit, to a user equipment (UE), a UE capability request message, receive, from the UE, a UE capability message including first information indicating support of an extended discontinuous reception (eDRX), which is longer than 10.24 seconds, in a radio resource control (RRC) inactive, and transmit, to the UE, a radio resource control (RRC) release message including paging information determined based on the first information indicating support of the eDRX longer than 10.24 seconds, wherein, based on the paging information included in the RRC release message, a paging monitoring operation is performed in the RRC inactive.

According to various embodiments of the disclosure, there are provided an enhanced UE and a base station.

In addition, according to various embodiments of the disclosure, there are provided an improved operation method of a UE having reduced capability and an apparatus performing the same.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a structure of an NR system, which is referred to for description of the present disclosure;

FIG. 2 illustrates a radio access state shift in a next generation mobile communication system according to an embodiment of the present disclosure;

FIG. 3 illustrates a radio protocol structure in an LTE and NR system according to an embodiment of the present disclosure;

FIG. 4 illustrates an example of downlink and uplink channel frame structures in case that communication is performed based on a beam in an NR system according to an embodiment of the present disclosure;

FIG. 5 illustrates a contention-based 4-step random access procedure performed by a UE in the case of initial access to a base station, re-access, handover, or various other cases that require random access according to an embodiment of the present disclosure;

FIG. 6 illustrates an operation of broadcasting a paging occasion and a paging message by a base station (or a network) according to an embodiment of the present disclosure;

FIG. 7 illustrates a CN paging reception procedure of an idle mode UE (UE in RRC_Idle) according to an embodiment of the present disclosure;

FIG. 8 illustrates a RAN paging reception procedure of an inactive mode UE (UE in RRC_Inactive) according to an embodiment of the present disclosure;

FIG. 9 illustrates a procedure of determining a paging monitoring cycle by a UE according to an embodiment of the present disclosure;

FIG. 10 illustrates a paging procedure that uses eDRX according to an embodiment of the present disclosure;

FIG. 11 illustrates a UE device according to an embodiment of the present disclosure; and

FIG. 12 illustrates a base station device according to an embodiment of the present disclosure.

### DETAILED DESCRIPTION

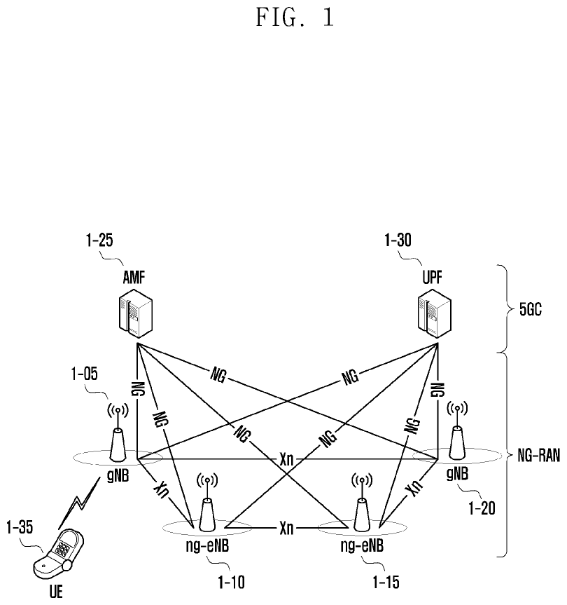

FIGS. 1 through 12, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, the operation principle of the disclosure will be described in detail with reference to the accompanying drawings. In the following description of the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as used below, and other terms referring to subjects having equivalent technical meanings may be used.

In the following description of the disclosure, terms and names defined in LTE and NR standards, which are the latest standards specified by the 3rd generation partnership project (3GPP) group among existing communication standards, will be used for the sake of descriptive convenience. However, the disclosure is not limited by these terms and names, and may be applied in the same way to systems that conform other standards. In particular, the disclosure may be applied to 3GPP NR (5th generation mobile communication standard).

FIG. 1 illustrates a structure of an NR system, which is referred to for description of the present disclosure. Referring to FIG. 1, the wireless communication system is configured with various base stations 1-05, 1-10, 1-15, and 1-20, an access and mobile management function (AMF) 1-20, and a user plane function (UPF) 1-30. A user equipment (UE) (or a terminal) 1-35 accesses an external network via the base station 1-05, 1-10, 1-15, and 1-20 and the UPF 1-30.

The base stations 1-05, 1-10, 1-15, and 1-20 are access nodes of a cellular network and provide radio access to UEs that accesses a network. That is, in order to service traffic of users, the base station 1-05, 1-10, 1-15, and 1-20 may perform scheduling by collecting state information such as buffer states, available transmission power states, channel states, or the like of UEs, and may support connection between the UEs and a core network (CN) (particularly, a CN in NR is referred to as 5GC). A user plane (UP) related to actual user data transmission and a control plane (CP) such as connection management or the like may be separately configured in communication. A gNB 1-05 and 1-20 uses UP and CP technologies defined in NR technology, and an ng-eNB 1-10 and 1-15, although the gNB is connected to 5GC, uses UP and CP technologies defined in LTE technology.

An AMF/session management function (SMF) 1-25 is a device that is in charge of various control functions in addition to a mobility management function associated with a UE, and is connected to various base stations, and the UPF 1-30 is a type of gateway device that provides data transmission.

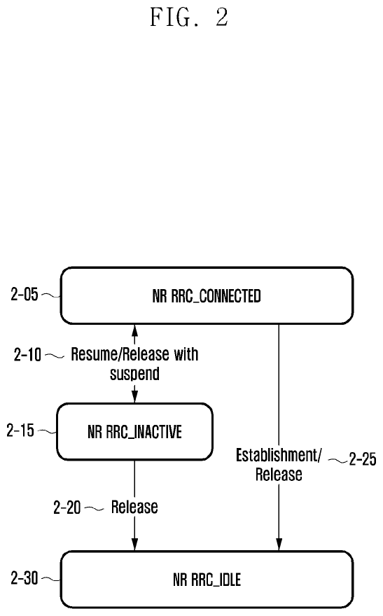

FIG. 2 illustrates a radio access state shift in a next generation mobile communication system according to an embodiment of the present disclosure.

In the next generation mobile communication system, a UE may have three types of radio access states (radio resource control (RRC) states). A connection mode (RRC_CONNECTED) 2-05 indicates that a UE is in a radio access state that enables data transmission or reception. An idle mode (RRC_IDLE) 2-30 indicates that a UE is in a radio access state that monitors whether paging is transmitted to the UE. The connection mode 2-05 and the idle model 2-30 may be radio access states that are also applicable to the LTE system, and detailed technologies thereof are the same as those of the LTE system. In the next generation mobile communication system, an inactive mode (RRC_INACTIVE) 2-15 is newly applied in addition to the connection mode 2-05 and the idle mode 2-30. The RRC_INACTIVE radio access state newly defined in the next generation mobile communication system may correspond to an inactive radio access state, an INACTIVE mode, an inactive mode, or the like.

In the radio access state of the inactive mode 2-15, UE context is maintained in a base station and a UE, and radio access network (RAN)-based paging may be supported. The characteristics of the radio access state of the inactive mode 2-15 are as follows:
Cell re-selection mobility;
CN-NR RAN connection (both C/U-planes) has been established for UE;
The UE AS context is stored in at least one gNB and the UE;
Paging is initiated by NR RAN (i.e., RAN paging);
RAN-based notification area is managed by NR RAN; and
NR RAN knows the RAN-based notification area which the UE belongs to.

According to an embodiment, the inactive mode 2-15 may be shifted to the connection mode 2-05 or the idle mode 2-30 via a predetermined procedure.

Referring to operation 2-10, the inactive mode 2-15 may be shifted to the connection mode 2-05 according to a resume procedure, and the connection mode 2-05 may be shifted to the inactive mode 2-15 via a release procedure including suspend configuration information. In the above-described operation 2-10, one or more RRC messages may be transmitted or received between a UE and a base station, and the above-described operation 2-10 may be configured with one or more detailed steps.

Referring to operation 2-20, via a release procedure after resumption, the inactive mode 2-15 may be shifted to the idle mode 2-30.

Referring to operation 2-25, switch between the connection mode 2-05 and the idle mode 2-30 may be performed according to the general LTE technology. For example, via an establishment or release procedure, switch between the connection mode 2-05 and the idle mode 2-30 may be performed.

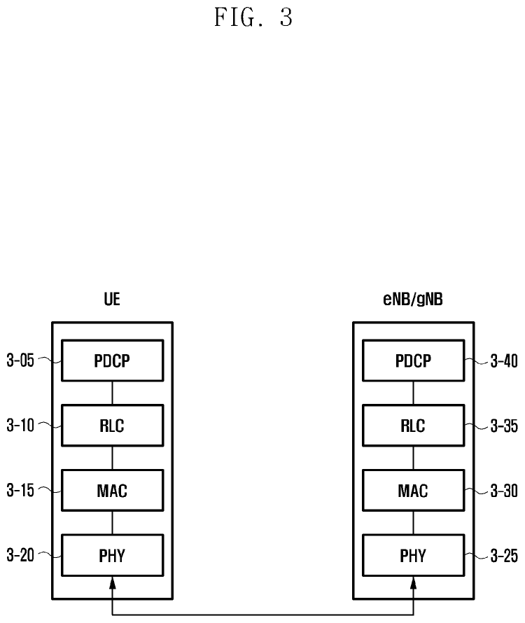

FIG. 3 illustrates a radio protocol structure in an LTE and NR system according to an embodiment of the present disclosure.

Referring to FIG. 3, the radio protocol of the LTE system may be configured with a packet data convergence protocol (PDCP) 3-05 and 3-40, a radio link control (RLC) 3-10 and 3-35, and a medium access control (MAC) 3-15 and 3-30 for each of a UE and an ENB. The packet data convergence protocol (PDCP) 3-05 and 3-40 is in charge of an IP header compression/decompression operation or the like, and a radio link control (RLC) 3-10 and 3-35 reconfigures a PDCP packet data unit (PDU) to have an appropriate size. The MAC 3-15 and 3-30 is connected to various RLC layer devices configured for a UE, and multiplexes RLC PDUs to a MAC PDU and demultiplexes RLC PDUs from a MAC PDU. The physical layer 3-20 and 3-25 may perform channel coding and modulation of higher layer data so as to produce an orthogonal frequency division multiplexing (OFDM) symbol, and may transmit the same via a wireless channel, or may demodulate an OFDM symbol received via a wireless channel and may perform channel decoding thereon, so as to transfer the same to a higher layer. In addition, in order to perform additional error correction in the physical layer, hybrid automatic repeat request (HARQ) is used. A reception end transmits 1 bit indicating whether a packet transmitted from a transmission end is received. This is referred to as HARQ acknowledge/negative acknowledge (ACK/NACK) information.

Downlink HARQ ACK/NACK information with respect to uplink data transmission is transmitted via a physical hybrid-ARQ indicator channel (PHICH) physical channel in the case of LTE. In the case of NR, whether retransmission is needed or new transmission is needed may be determined via scheduling information of a corresponding UE in a physical downlink control channel (PDCCH) that is a channel that transmits downlink/uplink resource allocation or the like. This is because an asynchronous HARQ is applied in NR. Uplink HARQ ACK/NACK information with respect to downlink data transmission may be transmitted via a physical uplink control channel (PUCCH) or a physical uplink shared channel (PUSCH). Generally, the PUCCH is transmitted in an uplink of a PCell to be described later. However, in the case in which it is supported by a UE, a base station additionally performs transmission to the corresponding UE in an SCell to be described later, which is referred to as a PUCCH SCell.

Although not illustrated in the drawings, an RRC layer is present above the PDCP layer of each of the UE and the base station. In the RRC layer, configuration control messages related to access and measurement may be transmitted or received for radio resource control.

The PHY layer 3-20 and 3-25 may be configured with one or multiple frequencies/carriers. A technology that concurrently configures multiple frequencies to use is referred to as carrier aggregation (CA). In case that compared to the case in which only a single carrier used to be used for communication between a UE and a base station, a single main carrier and one or multiple subcarriers are additionally used in the CA technology, and thus the amount of transmission is increased dramatically in proportion to the number of the subcarriers. A cell of a base station which uses a main carrier is referred to as a primary cell or PCell, and a cell of a base station which uses a subcarrier is referred to as a secondary cell or SCell.

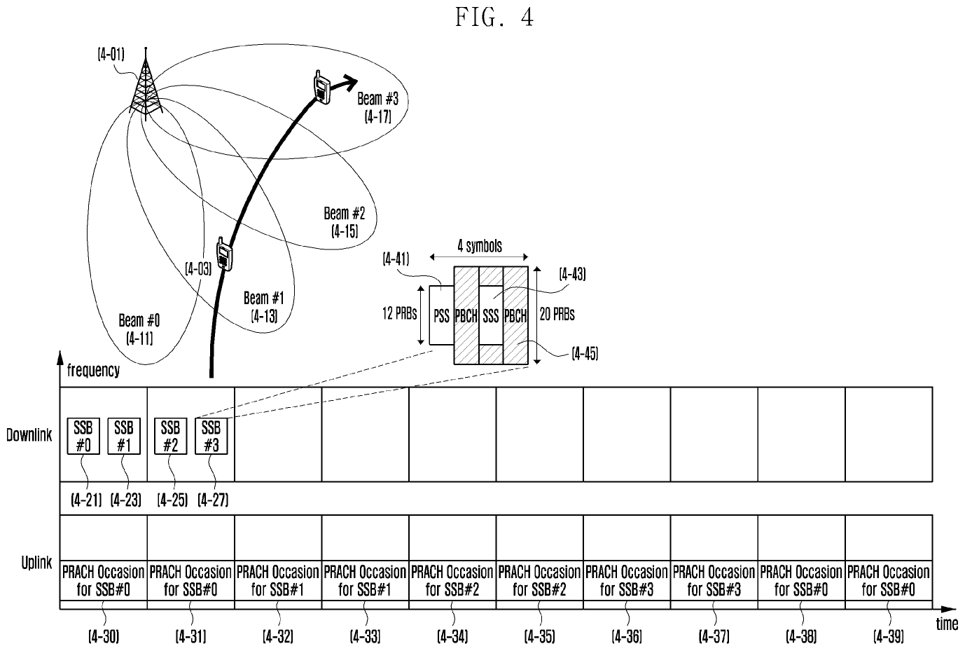

FIG. 4 illustrates an example of downlink and uplink channel frame structures in case that communication is performed based on a beam in an NR system according to an embodiment of the present disclosure.

In FIG. 4, a base station 4-01 transmits a signal in the form of a beam 4-11, 4-13, 4-15, and 4-17 in order to transmit an intensive signal or for broader coverage. Accordingly, a UE 4-03 in a cell needs to perform data transmission or reception by using a predetermined beam (beam #1 4-13 in the drawing) transmitted by the base station.

The state of a UE is classified as an idle mode (RRC_IDLE) or a connection mode (RRC_CONNECTED) depending on whether the UE is connected to the base station. Accordingly, the base station may not be aware of the location of a UE that is in the idle mode state.

In the case in which a UE in the idle mode state needs to shift to the connection mode state, the UE may receive a synchronization block (synchronization signal blocks (SSB)) 4-21, 4-23, 4-25, and 4-27 transmitted from the base station. The SSB is an SSB signal that is periodically transmitted according to a cycle set by the base station. Each SSB is classified as a primary synchronization signal (PSS) 4-41, a secondary synchronization signal (SSS) 4-43, and a physical broadcast channel (PBCH).

In the drawing, the scenario in which an SSB is transmitted for each beam is assumed. For example, it is assumed that SSB #0 4-21 is transmitted by using beam #0 4-11, SSB #1 4-23 is transmitted by using beam #1 4-13, SSB #2 4-25 is transmitted by using beam #2 4-15, and SSB #3 4-27 is transmitted by using beam #3 4-17. In the drawing, the situation in which an idle mode UE is present in beam #1 is assumed. However, although a connection mode UE performs random access, the UE selects an SSB received at the point in time of performing random access.

Accordingly, the UE receives SSB #1 transmitted in beam #1. Upon receiving SSB #1, the UE may obtain a physical cell identifier (PCI) of the base station via a PSS and an SSS, and, by receiving a PBCH, may recognize the identifier (i.e., #1) of an SSB currently received, may recognize a location in a 10 ms frame where the current SSB is received, and may also recognize a system frame number (SFN) at which the UE is among SFNs having a cycle of 10.24 seconds. In addition, a master information block (MIB) is included in the PBCH, and the MIB indicates a location where system information block type 1 (SIB1) that broadcasts detailed cell configuration information is to be received. Upon receiving SIB1, the UE may be aware of the total number of SSBs transmitted by the base station, and may recognize the location (the drawing assumes the scenario in which allocation is performed at intervals of 1 ms: diagrams 4-30 to 4-39) of a physical random access channel (PRACH) occasion capable of performing random access for shifting to a connection mode state (more precisely, capable of transmitting a preamble that is a physical signal specially designed for uplink synchronization).

In addition, based on the information, it is identified that which PRACH occasion among the PRACH occasions is mapped to which SSB index. For example, in the drawing, the scenario in which allocation is performed at intervals of 1 ms is assumed, and the scenario in which ½ SSB is allocated for each PRACH occasion (i.e., two PRACH occasions per SSB) is assumed. Accordingly, the scenario is illustrated in which two PRACH occasions is allocated for each SSB from the start of an PRACH occasion that starts based on an SFN value. That is, in the scenario, diagrams 4-30 and 4-31 are allocated for SSB #0, and drawings 4-32 and 4-33 are allocated for SSB #1. After configuration is performed with respect to all SSBs, PRACH occasions 4-38 and 4-39 are allocated again for the first SSB.

Accordingly, the UE recognizes the location of PRACH occasions 4-32 and 4-33 for SSB #1, and, accordingly, may transmit a random access preamble via the earliest PRACH occasion (e.g., the PRACH occasion 4-32) at the present point between the PRACH occasions 4-32 and 4-33 corresponding to SSB #1. The base station receives the preamble in the PRACH occasion 4-32, and thus may recognize that the corresponding UE selects SSB #1 to transmit the preamble. Accordingly, the base station may perform data transmission or reception via the corresponding beam in case that performing subsequent random access.

In case that a UE in the connection state moves from the current (source) base station to a destination (target) base station for some reasons such as handover or the like, the UE may also perform random access in the target base station, and may select an SSB in the same manner as the above description so as to transmit random access. In addition, in the case of handover, the source base station transmits, to the UE, a handover command to move to the target base station. In this instance, a random access preamble identifier dedicated to the corresponding UE may be allocated for each SSB of the target base station in the message, so as to be used in case that random access is performed in the target base station. In this instance, the base station may not allocate a dedicated-random access preamble identifier for every beam (depending on the current location of a UE or the like).

Accordingly, a dedicated-random access preamble may not be allocated to some SSBs (e.g., a dedicated-random access preamble is allocated to only beams #2 and #3). In the case in which a dedicated-random access preamble is not allocated to a SSB that the UE selects for preamble transmission, the UE may randomly select a contention-based random access preamble and may perform random access. For example, there may be the scenario in which a UE initially performs random access by locating itself in beam #1 but fails, and performs dedicated-preamble transmission by locating itself in beam #3 in case that performing random access preamble transmission again. In the case in which preamble retransmission is performed in random access, that is, in a single random access procedure, a contention-based random access procedure and a non-contention-based random access procedure may be mixedly performed depending on whether a dedicated-random access preamble is allocated to an SSB selected for each preamble transmission.

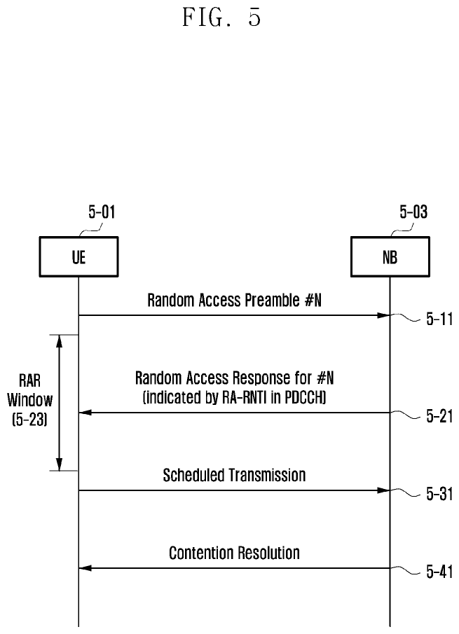

FIG. 5 illustrates a contention-based 4-step random access procedure performed by a UE in the case of initial access to a base station, re-access, handover, or various other cases that require random access according to an embodiment of the present disclosure.

A UE 5-01 selects a PRACH according to FIG. 4 described above, in order to access a base station (node B) 5-03, and transmits a random access preamble in the PRACH in operation 5-11. There may be the case in which one or more UEs simultaneously transmit random access preambles in the PRACH resource. The PRACH resource may be present through a single subframe, or only some symbols in the single subframe may be used. Information associated with the PRACH resource may be included in system information that the base station broadcasts, and, accordingly, a time and frequency resource used for transmitting a preamble may be identified. In addition, the random access preamble is a predetermined sequence that is specially designed so that the random access preamble is receivable even in case that the UE transmits before being completely synchronized with the base station. There may be multiple preamble indices (index) depending on a standard, and, in case that there are multiple preamble identifiers, a preamble transmitted by the UE may be a preamble randomly selected by the UE, or may be a preamble predetermined by the base station.

In the case in which the base station receives the preamble, the base station transmits a random access response (RAR) message (also referred to as Msg2) to the UE in operation 5-21. The RAR message may include identification information of the preamble used in operation 5-11, uplink transmission timing adjustment information, and uplink resource allocation information, temporary UE identifier information, and the like to be used for a subsequent operation (i.e., operation 5-31). In the case of the identification information of the preamble, for example, if multiple UEs transmit different preambles and perform random access in operation 5-11, the RAR message may include responses for respective preambles and may be transmitted in order to inform of which preamble the corresponding response is for. The uplink resource allocation information that is included in a response for each preamble may be detailed information of a resource that the UE is to use in operation 5-31, and may include the physical location and size of a resource, a decoding and coding ((modulation and coding) MCS)) scheme used for transmission, power adjustment information for transmission, and the like. In the case in which the UE that transmits the preamble performs initial access, the UE does not include an identifier that the base station allocates for communication with the base station, and thus the temporary UE identifier information may be transmitted to indicate a value to be used for this case.

The RAR message may include a response(s) for each preamble and may optionally include a backoff indicator (BI). In the case in which a random access preamble needs to be retransmitted since random access is not successfully performed, the preamble is not immediately retransmitted but the backoff indicator may be transmitted in order to delay transmission randomly based on the value of the backoff indicator. More particularly, if the UE does not properly receive an RAR, or if contention to be described later is improperly resolved, the random access preamble needs to be retransmitted. In this instance, the following index value may be indicated as the backoff indicator, and the UE selects a random value in the range of values from 0 to the value indicated the index value, and may retransmit the random access preamble after a period of time corresponding to the value elapses. For example, in the case in which the base station indicates a BI value of 5 (i.e., 60 ms) and the UE randomly selects 23 ms in the range of 0 to 60 ms, the UE may store the selected value in a parameter called PREAMBLE_BACKOFF, and the UE performs a procedure of retransmitting the preamble after 23 ms. In the case in which the backoff indicator is not transmitted, in case that random access is not successfully performed and the random access preamble needs to be retransmitted, the UE may immediately transmit the random access preamble. [TABLE 1] shows the index and the backoff parameter value.

TABLE 1

| | Backoff Parameter value |
|---|---|
| Index | (ms) |
| 0 | 5 |
| 1 | 10 |
| 2 | 20 |
| 3 | 30 |
| 4 | 40 |
| 5 | 60 |
| 6 | 80 |
| 7 | 120 |
| 8 | 160 |
| 9 | 240 |
| 10 | 320 |
| 11 | 480 |
| 12 | 960 |
| 13 | 1920 |
| 14 | Reserved |
| 15 | Reserved |

The RAR message needs to be transmitted within a predetermined period from a predetermined period of time after sending the preamble, and the period is referred to as a “RAR window.” The RAR window starts from a predetermined period of time after first preamble transmission. The predetermined period of time may be a value in units of subframes (1 ms) or less. In addition, the length of an RAR window may be a predetermined value that the base station configures for each PRACH resource or for one or more PRACH resource sets in a system information message broadcasted by the base station.

In case that the RAR message is transmitted, the base station may schedule the corresponding RAR message via a PDCCH. The corresponding scheduling information may be scrambled by using a random access-radio network temporary identifier (RA-RNTI). The RA-RNTI may be mapped to a PRACH resource that is used for transmitting the message in operation 5-11, and the UE that transmits a preamble in a predetermined PRACH resource may attempt PDCCH reception based on the corresponding RA-RNTI and may determine whether a corresponding RAR message is present. That is, in the case in which the RAR message is a response to the preamble that the UE transmits in operation 5-11 as shown in the drawing, the RA-RNTI used in the RAR message scheduling information may include information associated with corresponding transmission of operation 5-11. To this end, the RA-RNTI may be calculated via the following equation.

$$RA - RNTI = 1 + s\_id + 14 \times t\_id + 14 \times 80 \times f\_id + 14 \times 80 \times 8 \times ul\_carrier \_id$$

In this instance, s_id denotes an index corresponding to a first OFDM symbol at which the preamble transmission starts, which is transmitted in operation 5-11, and may have a value in the range of 0≤s_id<14 (i.e., the maximum number of OFDMs in a single slot). In addition, t_id denotes an index corresponding to a first slot in which the preamble transmission starts, which is transmitted in operation 5-11, and may have a value in the range of 0≤ t_id<80 (e.g., the maximum number of slots in a single system frame (10 ms)). In addition, f_id denotes what numbered PRACH resource is used for transmission of the preamble, transmitted in operation 5-11, in the frequency, and may have a value in the range of 0≤ f_id<8 (i.e., the maximum number of PRACHs in the frequency within the same time). In the case in which two carriers are used for a single cell in an uplink, ul_carrier_id is a factor to distinguish whether the preamble is transmitted in a normal uplink (NUL) (0 in this case), or whether the preamble is transmitted in a supplementary uplink (SUL) (1 in this case).

In operation 5-31, the UE that receives the RAR message may transmit a message different depending on a purpose described above, in a resource allocated to the RAR message. A message transmitted third in the drawing is referred to as Msg3 (i.e., the preamble in operation 5-11 or 5-13 is referred to as Msg1, and the RAR in operation 5-21 is referred to as Msg2). As an example of Msg3 transmitted by the UE, an RRCSetupRequest message which is a message in the RRC layer is transmitted in the case of initial access. An RRCReestablishmentRequest message is transmitted in the case of re-access. An RRCReconfigurationComplete message is transmitted in the case of handover. RRCResumeRequest is transmitted in the case of an inactive mode. Alternatively, a buffer status report (BSR) message for requesting a resource, or the like may be transmitted.

Subsequently, in the case of initial transmission (e.g., Msg3 does not include base station identification information allocated to the UE in advance, or the like), the UE receives a contention resolution message from the base station in operation 5-41, and the contention resolution message may include the content that the UE transmits in Msg3 as it is and may imply a UE that is related to a response although multiple UEs select the same preamble in operation 5-11 or 5-13.

Although NR supposes to support a frequency bandwidth of a broadband (e.g., 100 MHZ), all UEs may not need to support a broadband. For example, a wearable device such as a smartwatch or the like may need only a predetermined degree of bandwidth that enables communication. Therefore, there is a need of a UE simplified to have essential functions based on requirements of existing NR UEs, and the UE is referred to as a “reduced capability (RedCap)” UE. In the case of the RedCap UE, a bandwidth is smaller than those of existing NR UEs, for example, 10 MHz or 20 MHz, and a subcarrier spacing (SCS) supported is only a basic value, such as 15 KHz. In addition, a supported maximum data rate is limited to 20 Mbps or the like.

In addition, among RedCap UEs, there may be devices incapable of including multiple antennas since the size of the devices are small such as a wearable device. Accordingly, a UE that includes a smaller number of antennas than the existing UE may be considered. For example, there may be a RedCap UE including only a single reception antenna, which is referred to as a “RedCap UE having 1RX (RedCap 1RX UE).”

In addition, in order to extend the RedCap UE market, there is also a need of a UE that requires a relatively low cost, consumes relatively low energy, and supports a relatively low data transmission rate, in case that compared to a RedCap UE. This is referred to as an enhanced RedCap (eRedCap) UE or a Rel-18 RedCap UE (since it is treated as a work item of 3GPP NR Release-18). An eRedCap UE is further simplified, in case that compared to the existing RedCap UE. For example, the baseband bandwidth of a physical downlink shared channel (PDSCH) and a physical uplink shared channel (PUSCH) may be 5 MHz. For example, a bandwidth corresponding to the maximum number of unicasts physical resource blocks (PRBs) that a UE is capable of processing in a single slot may be limited.

In case that the UE performs random access, the base station may receive Msg1 in operation 5-11 and may indicate uplink resource information to be used in case that the UE transmits Msg3 via the RAR in operation 5-21. This may be indicated via an uplink (UL) grant field in the RAR. For example, a PUSCH time resource allocation field in the UL grant may be indicated by 4-bit information (=m), and may indicate time information of the uplink resource. The 4-bit information (=m) may indicate an m+1th row in a predetermined table (e.g., Table 2). For example, in the case in which the value of PUSCH time resource allocation is 3 (m=3), this indicates a 4th row in a predetermined table (e.g., Table 2). In the case in which the value of PUSCH time resource allocation is 15 (m=15), this indicates a 16th row in a predetermined table (e.g., Table 2). The table may be indicated by PUSCH-TimeDomainResourceAllocationList in PUSCH-ConfigCommon. Alternatively, the in case in which PUSCH-TimeDomainResourceAllocationList is not present in PUSCH-ConfigCommon, Table 2 (in the case of a normal cyclic prefix) and Table 3 (in the case of an extended cyclic prefix) may be used.

TABLE 2
Default PUSCH time domain resource allocation A for normal CP

| | PUSCH | | | |
|---|---|---|---|---|
| Row index | mapping type | K₂ | S | L |
| 1 | Type A | j | 0 | 14 |
| 2 | Type A | j | 0 | 12 |
| 3 | Type A | j | 0 | 10 |
| 4 | Type B | j | 2 | 10 |
| 5 | Type B | j | 4 | 10 |
| 6 | Type B | j | 4 | 8 |
| 7 | Type B | j | 4 | 6 |
| 8 | Type A | j + 1 | 0 | 14 |
| 9 | Type A | j + 1 | 0 | 12 |
| 10 | Type A | j + 1 | 0 | 10 |
| 11 | Type A | j + 2 | 0 | 14 |
| 12 | Type A | j + 2 | 0 | 12 |
| 13 | Type A | j + 2 | 0 | 10 |
| 14 | Type B | j | 8 | 6 |
| 15 | Type A | j + 3 | 0 | 14 |
| 16 | Type A | j + 3 | 0 | 10 |

TABLE 3
Default PUSCH time domain resource
allocation A for extended CP

| | PUSCH | | | |
|---|---|---|---|---|
| Row index | mapping type | K₂ | S | L |
| 1 | Type A | j | 0 | 8 |
| 2 | Type A | j | 0 | 12 |
| 3 | Type A | j | 0 | 10 |
| 4 | Type B | j | 2 | 10 |
| 5 | Type B | j | 4 | 4 |
| 6 | Type B | j | 4 | 8 |
| 7 | Type B | j | 4 | 6 |
| 8 | Type A | j + 1 | 0 | 8 |
| 9 | Type A | j + 1 | 0 | 12 |
| 10 | Type A | j + 1 | 0 | 10 |
| 11 | Type A | j + 2 | 0 | 6 |
| 12 | Type A | j + 2 | 0 | 12 |
| 13 | Type A | j + 2 | 0 | 10 |
| 14 | Type B | j | 8 | 4 |
| 15 | Type A | j + 3 | 0 | 8 |
| 16 | Type A | j + 3 | 0 | 10 |

Here, j may be determined based on a subcarrier spacing (numerology=μPUSCH) of a PUSCH according to Table 4.

TABLE 4
Definition of value j

| μPUSCH | j |
|---|---|
| 0 | 1 |
| 1 | 1 |
| 2 | 2 |
| 3 | 3 |
| 5 | 11 |
| 6 | 21 |

K2 (or K2) in Table 2 or Table 3 may indicate a slot offset, by which a UE may calculate a slot in which a PUSCH resource (e.g., Msg3) is transmitted based on a slot (e.g., an RAR) in which a resource is configured. In the case in which the UE transmits a PUSCH (Msg3) resource scheduled based on an RAR, the UE may calculate a slot offset by additionally adding a value of Δ to K2. The value of A may be determined based on a subcarrier spacing (numerology=μPUSCH) of the PUSCH according to Table 5.

TABLE 5
Definition of value Δ

| μPUSCH | Δ |
|---|---|
| 0 | 2 |
| 1 | 3 |
| 2 | 4 |
| 3 | 6 |
| 5 | 24 |
| 6 | 48 |

According to an embodiment of the disclosure, the UE may indicate, to the base station, whether the UE is an eRedCap UE or not by using Msg1. This may be referred to as Msg1-based early indication (EI) or Msg1 EI. For example, the base station may provide a preamble(s) dedicated only to an eRedCap to UEs, and an eRedCap UE (or only an eRedCap UE) may perform random access by using the corresponding preamble. In the case in which a UE transmits Msg1 by using the corresponding preamble, the base station may identify that the corresponding UE is an eRedCap UE. As another example, the base station may separately allocate an initial uplink BWP that is only for an eRedCap UE, and an eRedCap UE (or only an eRedCap UE) may use the resource. In the case in which a UE transmits Msg1 by using a preamble in the corresponding resource, the base station may identify that the corresponding UE is an eRedCap UE.

According to an embodiment of the disclosure, in the case in which the base station does not support eRedCap UE-dedicated Msg1 EI, the UE, in case that receiving Msg1, may not distinguish whether the corresponding UE is an eRedCap UE or a non-eRedCap UE (e.g., a RedCap UE, a normal NR UE). Because of the above, two problems may be caused.

In the case in which the base station transmits an RAR greater than or equal to 5 MHz and indicates a relatively short slot offset (short K2 in consideration of a normal UE) for UL grant for Msg3 in the RAR, and a UE that performs random access (a UE that transmits Msg1) is an eRedCap UE, the eRedCap UE may not transmit Msg3 in the configured slot offset. The eRedCap UE may need more time (slot) for receiving and processing an RAR greater than or equal to 5 MHz.

In the case in which the base station transmits an RAR greater than or equal to 5 MHz and indicates a relatively long slot offset (long K2 in consideration of an eRedCap UE) for UL grant for Msg3 in the RAR, and a UE that performs random access (a UE that transmits Msg1) is a non-eRedCap UE, the non-eRedCap UE may not immediately transmit Msg3 but may perform delayed Msg3 transmission, even though the non-eRedCap UE quickly finishes receiving/processing the RAR.

Therefore, Msg1 EI dedicated to an eRedCap UE may be defined/supported. According to an embodiment of the disclosure, the base station may perform the following operations as shown in TABLE 6.

TABLE 6
Base station operation

| 1) | In the case in which the base station supports or allows eRedCap (e.g., Rel-18 | | |
|---|---|---|---|
| | RedCap), | | |
| | A. | if it is indicated that a UE is an eRedCap UE by the UE via Msg1 EI, | |
| | i. | | the base station may configure relatively long K2 for the UE via |
| | | | PUSCH time resource allocation in an RAR. |
| | B. | if it is not indicated that a UE is an eRedCap UE by the UE via Msg1 EI | |
| | | (including the case in which the base station does not configure Msg1 EI for | |
| | | the UE), | |
| | i. | | the base station may configure relatively short K2 for the UE via |
| | | | PUSCH time resource allocation in an RAR. |
| 2) | In the case in which the base station does not support or allow eRedCap (e.g., | | |
| | Rel-18 RedCap), | | |
| | A. | the base station may configure relatively short K2 for the UE via PUSCH | |
| | | time resource allocation in an RAR. | |
| | According to an embodiment of the disclosure, based on the bandwidth of an | | |
| | RAR, the base station may perform the following operations. | | |
| | In the case in which the base station supports or allows eRedCap (e.g., Rel-18 | | |
| | RedCap), | | |
| | A. | if it is indicated that a UE is an eRedCap UE by the UE via Msg1 EI, | |
| | i. | | in the case in which the bandwidth of a transmitted RAR (or the |
| | | | bandwidth of a PRB of an RAR) is greater than or equal to 5 MHz, |

| | |
|---|---|
| 1. | the base station may configure relatively long K2 for the |
| | UE via PUSCH time resource allocation in the RAR. |

| ii. | | in the case in which the bandwidth of a transmitted RAR (or the |
|---|---|---|
| | | bandwidth of a PRB of an RAR) is less than or equal to 5 MHz, |
| | 1. | the base station may configure relatively short K2 for the UE via |
| | | PUSCH time resource allocation in the RAR. |
| B. | if it is not indicated that a UE is an eRedCap UE by the UE via Msg1 EI | |
| | (including the case in which the base station does not configure Msg1 EI for | |
| | the UE), | |
| i. | | the base station may configure relatively short K2 for the UE via |
| | | PUSCH time resource allocation in an RAR. |
| In the case in which the base station does not support or allow eRedCap (e.g., | | |
| Rel-18 RedCap), | | |
| C. | the base station may configure relatively short K2 for the UE via PUSCH | |
| | time resource allocation in an RAR. | |
| According to an embodiment, based on whether the base station supports or | | |
| allows Msg1 EI, the base station may perform the following operations. | | |
| In the case in which the base station supports or allows eRedCap (e.g., Rel-18 | | |
| RedCap), | | |
| A. | in the case in which the base station supports or allows Msg1 EI, | |
| i. | | if it is indicated that a UE is an eRedCap UE by the UE via the Msg1 |
| | | EI, |

| | |
|---|---|
| 1. | the base station may configure relatively long K2 for the |
| | UE via PUSCH time resource allocation in an RAR. |

| | |
|---|---|
| ii. | if it is not indicated that a UE is an eRedCap UE by the UE via Msg1 |
| | EI (including the case in which the base station does not configure Msg1 |
| | EI for the UE), |

| | |
|---|---|
| 1. | the base station may configure relatively short K2 for the |
| | UE via PUSCH time resource allocation in an RAR. |

| B. | in the case in which the base station does not support or allow Msg1 EI, | |
|---|---|---|
| i. | | the base station may configure relatively long K2 for the UE via |
| | | PUSCH time resource allocation in an RAR. |

| In the case in which the base station does not support or allow eRedCap (e.g., | |
|---|---|
| Rel-18 RedCap), | |
| C. | the base station may configure relatively short K2 for the UE via PUSCH |
| | time resource allocation in an RAR. |

According to an embodiment, based on the bandwidth of an RAR transmitted by the base station, and based on whether the base station supports or allows Msg1 EI, the base station may perform the following operations.

In the case in which the base station supports or allows eRedCap (e.g., Rel-18 RedCap) as shown in TABLE 7.

TABLE 7
eRedCap operation

| D. | in the case in which the base station supports or allows Msg1 EI, | |
|---|---|---|
| i. | | if it is indicated that a UE is an eRedCap UE by the UE via Msg1 EI, |

| | |
|---|---|
| 1. | in the case in which the bandwidth of a transmitted RAR (or the |
| | bandwidth of a PRB of an RAR) is greater than or equal to 5 MHz, |

| | |
|---|---|
| A. | the base station may configure relatively long K2 for the UE |
| | via PUSCH time resource allocation in the RAR. |

| | |
|---|---|
| 2. | in the case in which the bandwidth of a transmitted RAR (or the |
| | bandwidth of a PRB of an RAR) is less than or equal to 5 MHz, |

| | |
|---|---|
| A. | the base station may configure relatively short K2 for the UE |
| | via PUSCH time resource allocation in the RAR. |

| | |
|---|---|
| ii. | if it is not indicated that a UE is an eRedCap UE by the UE via Msg1 |
| | EI (including the case in which the base station does not configure Msg1 |
| | EI for the UE), |

| | |
|---|---|
| 1. | the base station may configure relatively short K2 for the UE via |
| | PUSCH time resource allocation in an RAR. |

| a. | in the case in which the base station does not support or allow Msg1 EI, | |
|---|---|---|
| iii. | | in the case in which the bandwidth of a transmitted RAR (or the |
| | | bandwidth of a PRB of an RAR) is greater than or equal to 5 MHz, |

| | |
|---|---|
| 1. | the base station may configure relatively long K2 for the UE via |
| | PUSCH time resource allocation in the RAR. |

| | |
|---|---|
| iv. | in the case in which the bandwidth of a transmitted RAR (or the |
| | bandwidth of a PRB of an RAR) is less than or equal to 5 MHz, |

| | |
|---|---|
| 1. | the base station may configure relatively short K2 for the UE via |
| | PUSCH time resource allocation in the RAR. |

| 2) | In the case in which the base station does not support or allow eRedCap (e.g., | |
|---|---|---|
| | Rel-18 RedCap), | |
| | A. | the base station may configure relatively short K2 for the UE via PUSCH |
| | | time resource allocation in an RAR. |

| | |
|---|---|
| 3) | According to an embodiment of the disclosure, in the case in which Msg1 EI is |
| | not defined/is not used, the base station may provide PUSCH- |
| | TimeDomainResourceAllocationList separately for an eRedCap UE. For |
| | example, as a value for a UE different from eRedCap, the base station may |
| | include a parameter named pusch-TimeDomainAllocationList, which is in the |
| | form of PUSCH-TimeDomainResourceAllocationList, in PUSCH- |
| | ConfigCommon or an SIB, and may transmit the same. Independently of the |
| | above, as a value for an eRedCap UE, the base station may include a parameter |
| | named pusch-TimeDomainAllocationList-eRedCap, which is in the form of |
| | PUSCH-TimeDomainResourceAllocationList, in PUSCH-ConfigCommon or |
| | an SIB, and may transmit the same. The value of K2 included in pusch- |
| | TimeDomainAllocationList-eRedCap is set to a relatively long value, and a |
| | Msg3 transmission point may be configured to be late for an eRedCap UE. The |
| | value of K2 included in pusch-TimeDomainAllocationList is set to a relatively |
| | short value, and a fast Msg3 transmission point may be configured for a UE |
| | different from an eRedCap UE. |
| 4) | According to an embodiment of the disclosure, the UE may receive pusch- |
| | TimeDomainAllocationList and/or pusch-TimeDomainAllocationList-eRedCap |
| | via system information. According to an embodiment of the disclosure, in the |
| | case in which the UE supports eRedCap (and/or receives an RAR greater than |
| | or equal to 5 MHz), the UE may determine K2 by using pusch- |
| | TimeDomainAllocationList-eRedCap. In the case in which the UE does not |
| | support eRedCap (and/or the size of a received RAR is less than 5 MHz), the UE |
| | may determine K2 by using pusch-TimeDomainAllocationList. |
| 5) | According to an embodiment, via different K2 configurations of pusch- |
| | TimeDomainAllocationList and pusch-TimeDomainAllocationList-eRedCap, |
| | the base station may distinguish the point in time at which a UE that performs |
| | random access transmits Msg3, and may determine whether the corresponding |
| | UE is an eRedCap UE or not. That is, the operation may be defined as Msg3- |
| | based early indication. |

According to an embodiment, the UE may calculate a slot offset from an RAR to a scheduled PUSCH (Msg3) by adding K2 and Δ. Δ is a value defined in the standard, and may be a constant value based on numerology according to Table 5. According to an embodiment, an eRedCap UE-dedicated Δ may be separately defined (e.g., ΔeRedCap in table different from Table 5). According to an embodiment, in the case in which the UE does not support eRedCap (or in the case in which the size of a received RAR is smaller than 5 MHz), a slot offset from an RAR to a scheduled PUSCH (Msg3) may be calculated by adding K2 and Δ (Table 5). According to an embodiment of the disclosure, in the case in which the UE supports eRedCap (or in the case in which the size of a received RAR is greater than 5 MHz), a slot offset from an RAR to a scheduled PUSCH (Msg3) may be calculated by adding K2 and ΔeRedCap. ΔeRedCap may be defined to be higher than existing 4.

According to an embodiment, an additional slot offset (e.g., a) for an eRedCap UE may be defined. According to an embodiment, in the case in which the UE does not support eRedCap (or in the case in which the size of a received RAR is smaller than 5 MHz), a slot offset from an RAR to a scheduled PUSCH (Msg3) may be calculated by adding K2 and Δ (Table 5). According to an embodiment, in the case in which the UE supports eRedCap (or in the case in which the size of a received RAR is greater than 5 MHZ), a slot offset from an RAR to a scheduled PUSCH (Msg3) may be calculated by adding K2, Δ, and α.

According to an embodiment, by introducing ΔeRedCap or α, the UE that performs random access may distinguish the point in time at which the UE transmits Msg3. The base station may also distinguish the same, and may determine whether the corresponding UE is an eRedCap UE or not. That is, the operation may be defined as Msg3-based early indication.

According to an embodiment of the disclosure, an RAR may indicate a fallbackRAR of a 2-step random access.

According to an embodiment of the disclosure, the bandwidth of an RAR may indicate the bandwidth of a PRB corresponding to the RAR.

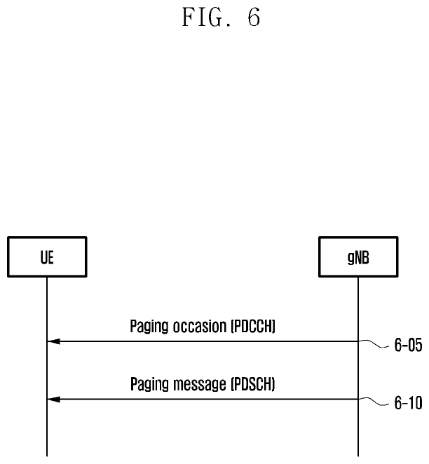

FIG. 6 illustrates an operation of broadcasting a paging occasion and a paging message by a base station (or a network) according to an embodiment of the present disclosure.

An NR-based 5G or next generation radio access network (next generation radio access network: NG-RAN) may be configured with NG-RAN nodes. Here, an NG-RAN node may be a gNB. A gNB may provide an NR user plane (UP) and control plane (CP) protocol end to a UE. In addition, gNBs are connected to 5G core (5GC) via an NG interface, and, more specifically, gNBs are connected to an AMF via an NG-control (NG-C) interface and are connected to a UPF via an NG-user (NG-U) interface. In a 5G (NR or new radio) wireless communication system, a UE may use discontinuous reception or DRX in order to reduce power consumption in an RRC_IDLE mode or RRC_INACTIVE mode. In an RRC_IDLE or RRC_INACTIVE state, a UE may not always monitor a PDCCH, but may monitor a PDCCH periodically (e.g., at every DRX cycle) during a short period of time in order to receive a paging occasion, to receive a system information (SI) update notification, or to receive an urgent notification. A paging message 6-10 may be transmitted via a physical downlink shared channel (PDSCH). In the case in which the paging message 6-10 is present in a PDSCH, a PDCCH may be marked as a paging radio network temporary identifier (P-RNTI).

A P-RNTI may be common to all UEs. A UE identity (e.g., a system architecture evolution (SAE) temporary mobile subscription identifier (S-TMSI) for a UE in an RRC_IDLE state or an inactive radio network temporary identifier (I-RNTI) for a UE in an RRC_INACTIVE state) may be included in the paging message 6-10, in order to indicate paging for a predetermined UE. The paging message 6-10 may include multiple UE identities for paging multiple UEs. The paging message 6-10 may be broadcasted (e.g., a PDCCH is masked with a P-RNTI) via a data channel (e.g., a PDSCH). A system information (SI) update and urgent notification may be included in downlink control information (DCI), and a PDCCH that carriers DCI may be marked as a P-RNTI. In the RRC_IDLE or RRC_INACTIVE mode, a UE may monitor a single paging occasion (PO) 6-05 at every DRX cycle. In the RRC_IDLE or RRC_INACTIVE mode, a UE may monitor a PO in an initial DL bandwidth part (BWP). In the RRC connection state, a UE may monitor one or more POs, and may receive an SI update notification and may receive an urgent notification. A UE may monitor all Pos in a paging DRX cycle, and may monitor at least one PO during an SI modification period. In the RRC_IDLE or RRC_INACTIVE mode, a UE may monitor a PO in an active DL BWP. A PO is a set of S PDCCH monitoring occasions for paging. Here, “S” denotes the number of synchronization signal and physical broadcast channel (PBCH) blocks (SSB) transmitted in a cell. A UE may determine a paging frame (PF), and then may determine a PO for the determined PF. A single PF may be a radio frame (10 ms). A method of determining a PF and a PO may be based on the following:
The PF for a UE is the radio frame with system frame number “SFN” which satisfies the equation (SFN+PF_offset) mod T=(T div N)*(UE_ID mod N);
Index (i_s), indicating the index of the PO is determined by i_s=floor (UE_ID/N) mod Ns;
T is DRX cycle of the UE;
In RRC_INACTIVE state, T is determined by the shortest of the UE specific

DRX value configured by RRC, UE specific DRX value configured by NAS, and a default DRX value broadcast in system information;
In RRC_IDLE state, T is determined by the shortest of UE specific DRX value configured by NAS, and a default DRX value broadcast in system information. If UE specific DRX is not configured by upper layers (i.e., NAS), the default value is applied;
N: number of total paging frames in T;
Ns: number of paging occasions for a PF;
PF_offset: offset used for PF determination;
UE_ID: 5G-S-TMSI mod 1024;
Parameters Ns, nAndPagingFrameOffset, and the length of default DRX Cycle are signaled in SIB1. The values of N and PF_offset are derived from the parameter nAndPagingFrameOffset as defined in TS 38.331. If the UE has no 5G-S-TMSI, for instance in case that the UE has not yet registered onto the network, the UE may use as default identity UE_ID=0 in the PF and i_s formulas above;
The PDCCH monitoring occasions for paging are determined based on paging search space configuration (paging-SearchSpace) signaled by gNB;
In the case in which SearchSpaceId=0 is configured for pagingSearchSpace, a PDCCH monitoring occasion for paging may be the same for remaining system information (RMSI) (refer to the definition in clause 13 in TS 38.213). In the case in which SearchSpaceId=0 is configured for pagingSearchSpace, Ns may be 1 or 2. In the case of Ns=1, only a single PO is present, which starts from a first PDCCH monitoring occasion for paging in a PF. In the case of Ns=2, a PO is present in a first half frame (i_s=0) or a second half frame (i_s=1) of a PF; and
In the case in which SearchSpaceId that is different from 0 is configured for pagingSearchSpace, a UE monitors a (i_s+1) th PO. A PDCCH monitoring occasion for paging may be determined based on paging search space configuration (paging-SearchSpace) signaled by a gNB. In the case of PDCCH monitoring for paging which does not overlap a UL symbol (determined based on tdd-UL-DL-ConfigurationCommon), PDCCH monitoring may be sequentially numbered from a first PDCCH monitoring occasion for paging with a number from 0 in a PF. A gNB may signal a parameter named firstPDCCH-MonitoringOccasionOfPO for each PO corresponding to a PF. In the case in which firstPDCCH-MonitoringOccasionOfPO is signaled, an (i_s+1) th PO is a set of “S” consecutive PDCCH monitoring occasions for paging that starts from a PDCCH monitoring occasion number indicated by firstPDCCH-MonitoringOccasionOfPO. A (that is, (i_s+1) th value of firstPDCCH-MonitoringOccasionOfPO parameter) or (i_s+1) th PO is a set of “S” consecutive PDCCH monitoring occasions for paging that starts from an (i_s*S) th PDCCH monitoring occasion. “S” denotes the number of SSBs that are actually transmitted and determined based on ssb-PositionsInBurst that is a parameter signaled in SystemInformationBlock1 received from a gNB. The parameter first-PDCCH-MonitoringOccasionOfPO may be signaled in SIB1 for paging in an initial DL BWP. In the case in which paging is performed in a DL BWP other than the initial DL BWP, the parameter first-PDCCH-MonitoringOccasionOfPO is signaled in the corresponding BWP configuration. For the detailed description thereof, refer to TS 38.304.

A PDCCH marked as a P-RNTI may transfer information based on DCI format 1_0. The following information may be information that is transmitted via DCI format 1-0 by using a cyclic redundancy check (CRC) scrambled by a P-RNTI:
Short Messages Indicator-2 bits according to Table 8;
Short Messages-8 bits according to Table 9. If only the scheduling information for Paging is carried, this bit field is reserved;
Frequency domain resource assignment—┌log₂(N_{RB}^{DL,BWP}N_{RB}^{DL,BWP}+1)/2┐ bits. If only the short message is carried, this bit field is reserved;
N_{RB}^{DL,BWP} is the size of CORESET 0;
Time domain resource assignment-4 bits as defined in Subclause 5.1.2.1 of [6, TS38.214]. If only the short message is carried, this bit field is reserved;
VRB-to-PRB mapping-1 bit according to Table 7.3.1.1.2-33 of [5, TS 38.212]. If only the short message is carried, this bit field is reserved;
Modulation and coding scheme-5 bits as defined in Subclause 5.1.3 of [6, TS38.214], using Table 5.1.3.1-1. If only the short message is carried, this bit field is reserved;
TB scaling-2 bits as defined in Subclause 5.1.3.2 of [6, TS38.214]. If only the short message is carried, this bit field is reserved; and
Reserved bits-6 bits.

Table 8 below lists short message indicators.

TABLE 8

| Bit | |
|---|---|
| field | Short Message indicator |
| 00 | Reserved |
| 01 | Only scheduling information for Paging is present in the DCI |
| 10 | Only short message is present in the DCI |
| 11 | Both scheduling information for Paging and short message are |
| | present in the DCI |

Table 9 below defines a short message. Bit 1 denotes a most significant bit.

| Bit | Short Message |
|---|---|
| 1 | systemInfoModification |
| | If set to 1: indication of a BCCH modification other than |
| | SIB6, SIB7 and SIB8. |
| 2 | etwsAndCmasIndication |
| | If set to 1: indication of an ETWS primary notification and/or |
| | an ETWS secondary notification and/or a CMAS notification. |
| 3-8 | Reserved |

In operation 6-05, the UE may detect PDCCH transmission from a gNB in order to monitor a PO, and the UE may identify the short message indicator, whereby the UE determines whether a paging message is present. Via the short message indicator, if it is determined that a paging message is present, the UE may receive a PDSCH (e.g., a paging message) in operation 6-10.

TABLE 10

| | |
|---|---|
| Paging ::= | SEQUENCE { |
| pagingRecordList | PagingRecordList |

OPTIONAL, -- Need N

| | |
|---|---|
| lateNonCriticalExtension | OCTET STRING |

OPTIONAL,

| | |
|---|---|
| nonCriticalExtension | SEQUENCE{} |

```
  OPTIONAL
  }
```

| | |
|---|---|
| PagingRecordList ::= | SEQUENCE (SIZE(1..maxNrofPageRec)) OF |

PagingRecord

| | |
|---|---|
| PagingRecord ::= | SEQUENCE { |
| ue-Identity | PagingUE-Identity, |
| access Type | ENUMERATED {non3GPP} OPTIONAL, -- Need N |

```
    ...
  }
```

| | |
|---|---|
| PagingUE-Identity ::= | CHOICE { |
| ng-5G-S-TMSI | NG-5G-S-TMSI, |
| fullI-RNTI | I-RNTI-Value, |

```
    ...
  }
```

A paging message format is as shown in Table 10. A single paging message may include a list having PagingRecord as an entry, and each entry may include a ue-Identity indicating which UE has paging. If a UE discovers the same PagingRecord as its UE identity (e.g., S-TMSI or I-RNTI) in the list, the UE may start an operation of shifting to an RRC connection mode.

There may be two types, which are classified based on which entity initiates paging. In the case of “CN-initiated paging” or “CN paging,” this is the case in which a CN, an AMF, or a mobility management entity (MME) initiates paging. In the case of “RAN-initiated paging” or “RAN paging,” this is the case in which a RAN (a base station, a gNB, or an eNB) initiates paging.

An idle mode UE may monitor a paging channel in order to receive CN paging. An inactive mode UE may monitor a paging channel in order to receive RAN paging, in addition to CN paging. UEs may not need to continuously monitor a paging channel. UEs may be required to monitor a paging channel during a paging occasion (PO) once at every DRX cycle defined in TS 38.304. A paging DRX cycle may be configured by a network:
1) For CN paging, a default cycle (or a default CN paging cycle or a default paging cycle) may be broadcasted via system information;
2) For CN paging, a UE specific cycle (or UE specific CN paging cycle) may be configured via NAS signaling; and
3) For RAN paging, a UE specific cycle (or UE specific RAN paging cycle or RAN paging cycle) may be configured via RRC signaling.

A UE may use the smallest value among DRX cycles applicable (i.e., configured) based on an RRC mode may be used as a paging monitoring cycle. That is, an idle mode UE may use a smaller value between a default CN paging cycle and a UE specific CN paging cycle (if configured). An inactive mode UE may use the smallest value among a default CN paging cycle, a UE specific CN paging cycle (if configured), and a RAN paging cycle (if configured).

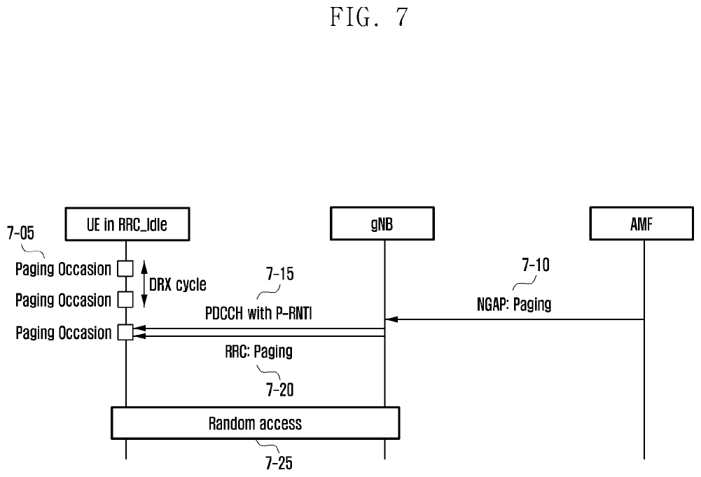

FIG. 7 illustrates a CN paging reception procedure of an idle mode UE (UE in RRC_Idle) according to an embodiment of the present disclosure.

An idle mode UE may monitor a paging channel during a paging occasion (PO) 7-05 at every DRX cycle previously defined for saving energy. That is, the UE may enter into a sleep mode at every interval between POs. At every PO, the UE may scan a PDCCH having a CRC scrambled by a P-RNTI. In the case in which a UPF receives downlink data toward the UE, the UPF may initiate an AMF's paging procedure via an SMF. In operation 7-10, the AMF may manage location information of a UE in units of registered tracking areas, and may broadcast an NG application protocol (NGAP) paging message to all gNBs in registered tracking areas to which the corresponding UE belongs. gNBs that receive the NGAP paging message may transmit PDCCHs (each having a CRC scrambled by a P-RNTI) appropriate for the PO of the UE (refer to operation 7-15 and operation 6-05 of FIG. 6). The UE that has been scanning a PDCCH may detect PDCCH transmission from a gNB, and may receive an RRC paging message (refer to operation 7-20 and operation 6-10 of FIG. 6). If the UE discovers PagingRecord that is the same as its UE identity (e.g., an S-TMSI or I-RNTI) in the RRC paging message, the UE may perform random access in order to establish an RRC connection (refer to operation 7-25).

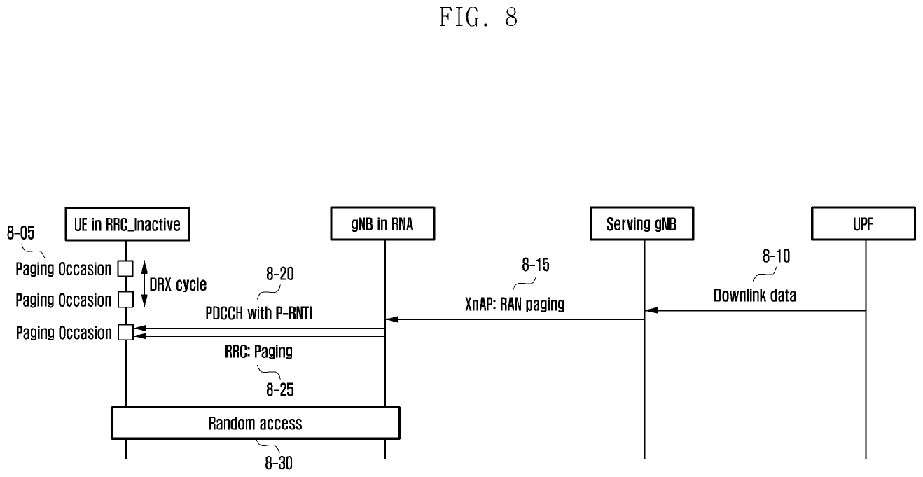

FIG. 8 illustrates a RAN paging reception procedure of an inactive mode UE (UE in RRC_Inactive) according to an embodiment of the present disclosure.

An inactive mode UE may monitor a paging channel during a paging occasion (PO) 8-05 at every DRX cycle previously defined for saving energy. That is, the UE may enter into a sleep mode at every interval between Pos. At every PO, the UE may scan a PDCCH having a CRC scrambled by a P-RNTI. If a UPF receives downlink data toward the UE, the UPF may transfer the received data to a serving base station (serving gNB) (refer to operation 8-10). The serving base station may store or manage the location record of a UE in units of RAN notification areas (RNA). Therefore, the serving base station may transfer an XnAP (Xn application protocol) RAN paging message to all gNBs in an RNA to which the corresponding UE belongs (refer to operation 8-15). gNBs that receive the XnAP RAN paging message may transmit PDCCHs (each having a CRC scrambled by a P-RNTI) appropriate for the PO of the UE (refer to operation 8-20 and operation 6-05 of FIG. 6). The UE that has been scanning a PDCCH may detect PDCCH transmission from a gNB, and may receive an RRC paging message (refer to operation 8-25 and operation 6-10 of FIG. 6). If the UE discovers PagingRecord that is the same as its UE identity (e.g., an S-TMSI or I-RNTI) in the RRC paging message, the UE may perform random access in order to resume an RRC connection (refer to operation 8-30).

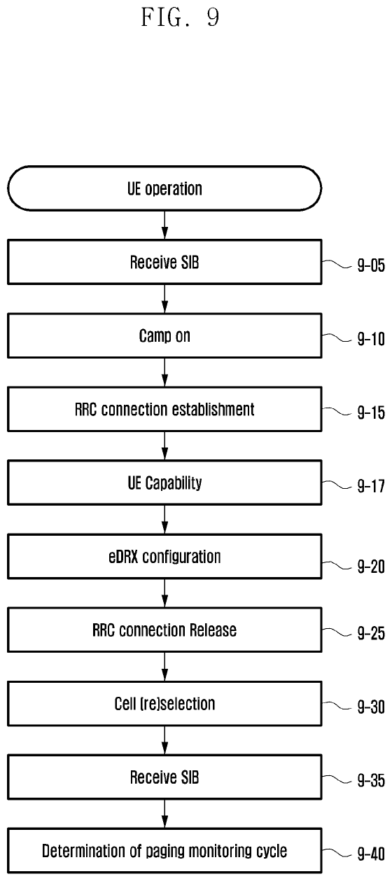

FIG. 9 illustrates a procedure of determining a paging monitoring cycle by a UE according to an embodiment of the present disclosure.

In operation 9-05, a UE may receive system information (SIB). In operation 9-10, the UE may select a single cell based on a single or multiple pieces of received system information, and may camp on the selected cell. Subsequently, in operation 9-15, the UE may establish an RRC connection to the cell. In operation 9-17, the UE may report UE capability. For example, the UE may report, to a base station, whether the UE supports eDRX (e.g., whether the UE supports RRC_INACTIVE eDRX). In operation 9-20, the UE that shifts to an RRC connection mode may receive an eDRX configuration (e.g., eDRX configuration for RRC_IDLE mode or CN paging) from a CN via negotiation using NAS signaling (e.g., attach request/accept, tracking area update request/accept message) with a CN (MME or AMF). In this instance, the eDRX configuration may include an eDRX cycle (e.g., TeDRX or TeDRX_IDLE). In this instance, paging time window (PTW) length information (e.g., a PTW or PTW_IDLE length) may be included in the eDRX configuration. In operation 9-25, the RRC connection configured for the UE is released and the UE may shift an RRC mode to an idle mode (RRC_IDLE) or an inactive mode (RRC_INACTIVE).

To shift the UE to the inactive mode, the base station may include eDRX configuration information (eDRX configuration information for an RRC_INACTIVE mode or RAN paging) in an RRC release message. In this instance, the eDRX configuration may include an eDRX cycle (e.g., TeDRX_INACTIVE). In this instance, paging time window (PTW) length information (e.g., a PTW_INACTIVE length) may be included in the eDRX configuration. In operation 9-30, an inactive or idle mode UE may perform cell selection or cell reselection by moving through many cells. In operation 9-35, the UE may receive an SIB of a base station or a camp-on cell. Through the above, the UE may receive whether the corresponding cell or base station allows or supports eDRX (e.g., eDRX-Allowed, eDRX-AllowedIdle, eDRX-AllowedInactive). In operation 9-40, the UE may calculate a paging monitoring cycle in an inactive or idle mode by using received eDRX configuration information, DRX configuration information, an SIB indicator, or the like, so as to monitor paging.

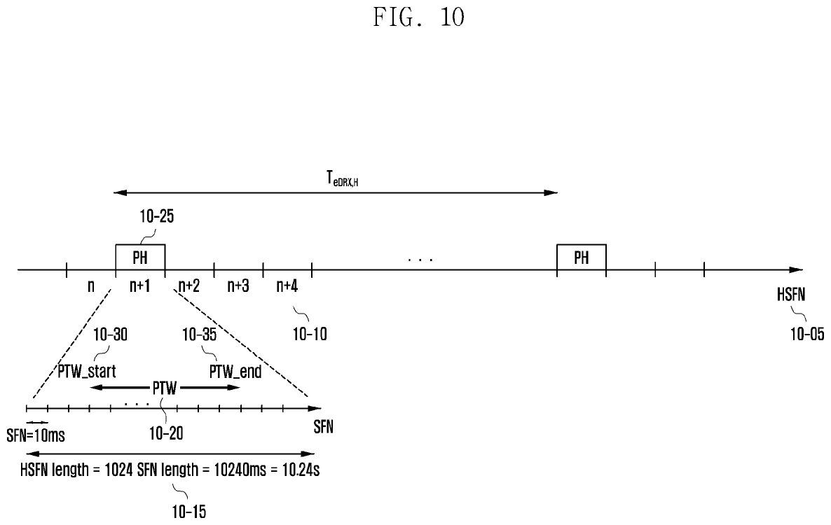

FIG. 10 illustrates a paging procedure that uses eDRX according to an embodiment of the present disclosure.

In the case in which eDRX is configured for an idle mode UE, the following may be applied:
In the idle mode, a DRX cycle may be extended up to 10.24 s or more, and may be extended to a maximum of 2621.44 s (43.69 minutes);
In case that a hyper slot frame number (Hyper-SFN or H-SFN or HSFN) 10-5 is broadcasted in a cell, every time that an SFN value finishes a cycle, a HSFN is increased by 1. Referring to operation 10-10 of FIG. 10, if a first HSFN is n, an HSFN may be increased in a manner that an HSFN subsequent thereto is n+1, and an HSFN subsequent thereto is n+2. Over time, an SFN value may be increased by 1 (10 ms per radio frame) from 0 to 1023. In case that the SFN reaches 1023, the SFN returns to 0. In this instance, the HSFN value may be increased by 1. Accordingly, referring to operation 10-15, the length of a single HSFN is the same as the length of 1024 SFNs, and may also be equal to 10240 ms (=10.24 s);
A paging hyperframe (PH) denotes a H-SFN at which a UE starts paging DRX monitoring during a PTW used in an ECM-IDLE mode. The PH may be determined based on an equation which an MME/AMF, a UE, and a base station are aware of, and may be determined by a function of a UE identity and an eDRX cycle;
During a PTW, 1) a UE may monitor paging 1) during a PTW period, or 2) until a paging message including a NAS identity of the UE is received (or until one that occurs earlier between the two events). The start offset of a PTW is regularly distributed in a PH, and may be defined according to TS 36.304;
An MME/AMF may determine the start points of a PH and a PTW by using an equation defined in TS 36.304. In addition, the MME/AMF may transmit an SI paging request during a PTW or immediately before the start of the PTW, in order to avoid a procedure in which a base station stores a paging message;
In case that a UE uses eDRX, requirements of an earthquake and tsunami warning system (ETWS), a commercial mobile alert service (CMAS), and a public warning system (PWS) may not be satisfied. For extended access barring (EAB), SIB14 may be obtained before RRC connection is established if a UE that uses eDRX supports SIB14; and
In the case in which an eDRX cycle is longer than a system information modification period, a UE may identify whether system information stored before RRC connection is established is valid. For a UE that is configured with an eDRX cycle longer than the system information modification period, a paging message including systemInfoModification-eDRX may be used for informing of system information modification.

A UE may receive an eDRX configuration including eDRX cycle (TeDRX) via NAS. The UE may operate according to eDRX only in case that the UE is configured with eDRX by NAS and a serving cell indicates support of eDRX via system information. If the UE is configured with TeDRX=512 radio frames, the UE may monitor a PO according to a legacy DRX operation with T=512 (clause 7.1 in TS 36.304). For other cases, the UE configured with eDRX may monitor a PO 1) according to a legacy DRX operation during a periodic PTW (clause 7.1 in TS 36.304), or 2) until a paging message including a NAS identity of the corresponding UE is received (until one that occurs earlier between the two events). A PTW 10-20 is a UE-specific PTW, and is determined by 1) paging hyperframe (PH) 10-25, 2) a PTW start point (PTW_start) 10-30 in the PH 10-25, and 3) a PTW end point (PTW_end) 10-35. The above-described three PTW determining factors are determined based on the following equation. According to an embodiment, depending on the PTW_start 10-30 and the length of the set PTW 10-20, the PTW_end 10-35 may indicate an SFN outside the PH 10-25 including the PTW_start 10-30.

TABLE 11
The PH is the H-SFN satisfying the following equation:
H-SFN mod TeDRX,H= (UE_ID_H mod TeDRX,H), where
- UE_ID_H:
- 10 most significant bits of the Hashed ID, if P-RNTI is monitored on
PDCCH or MPDCCH
- 12 most significant bits of the Hashed ID, if P-RNTI is monitored on
NPDCCH
- T eDRX,H : eDRX cycle of the UE in Hyper-frames, (TeDRX,H =1, 2, ... ,
256 Hyper-frames) (for NB-IoT, TeDRX,H =2, ..., 1024 Hyper-frames) and
configured by upper layers.
PTW_start denotes the first radio frame of the PH that is part of the PTW
and has SFN satisfying the following equation:
SFN = 256* ieDRX, where
- ieDRX = floor(UE_ID_H /TeDRX,H) mod 4
PTW_end is the last radio frame of the PTW and has SFN satisfying the
following equation:
SFN = (PTW_start + L*1−0 − 1) mod 1024, where
- L = Paging Time Window length (in seconds) configured by upper layers
Hashed ID is defined as follows:
Hashed_ID is Frame Check Sequence (FCS) for the bits b31, b30, ..., b0 of
S-TMSI or 5G-S-TMSI. 5G-S-TMSI is used for Hashed-ID if the UE
supports connection to 5GC and NAS indicated to use 5GC for the selected
cell.
S-TMSI = <b39, b38, ..., b0> as defined in TS 23.003 [35]
5G-S-TMSI = <b47, b46, ..., b0> as defined in TS 23.003 [35].
The 32-bit FCS may be the ones complement of the sum (modulo 2) of Y1
and Y2, where
- Y1 is the remainder of xk (x31 + x30 + x29 + x28 + x27 + x26 + x25 + x24
+ x23 + x22 + x21 + x20 + x19 + x18 + x17 + x16 + x15 + x14 + x13 + x12
+ x11 + x10 + x9 + x8 + x7 + x6 + x5 + x4 + x3 + x2 + x1 + 1) divided
(modulo 2) by the generator polynomial x32 + x26 + x23 + x22 + x16 + x12
+ x11 + x10 + x8 + x7 + x5 + x4 + x2 + x + 1, where k is 32; and
- Y2 is the remainder of Y3 divided (modulo 2) by the generator polynomial
x32 + x26 + x23 + x22 + x16 + x12 + x11 + x10 + x8 + x7 + x5 + x4 + x2 +
x + 1, where Y3 is the product of x32 “y ″b31, b30, ..., b0 of S-TMSI or 5G-
S-TMSI,,” i.e., Y3 is the generator polynomial x32 (b31*x31 + b30*x30 + ...
+ b0*1).
NOTE: The Y1 is 0xC704DD7B for any S-TMSI or 5G-S-TMSI value.

Based on an RRC state of the UE, based on whether the UE is within or beyond a PTW, based on a TeDRX setting (e.g., operation 9-20), and based on whether a cell that the UE camps on supports eDRX (e.g., operation 9-35), a UE configured with eDRX may monitor a PO in cycles as described below. (rf=radio frame, UE specific cycle=UE specific CN paging cycle, Default cycle=Default CN paging cycle)

1. An RRC_IDLE UE may determine a paging monitoring cycle (TDRX_IDLE,LTE) as shown below for each of the three cases (Case 1IDLE,LTE, 2IDLE,LTE, 3IDLE,LTE) as shown in TABLE 12.

```
TABLE 12
* Note: min denotes a function of outputting the minimum value of only the
values configured for a UE among input values.
- Case 1IDLE,LTE) TeDRX is not configured, or a camp-on cell does not allow
eDRX.
  => TDRX_IDLE,LTE = min (UE specific paging cycle, Default paging cycle)
- Case 2IDLE,LTE) TeDRX = 512rf (=5.12 seconds) is configured, and a camp-
on cell allows eDRX.
  => TDRX_IDLE,LTE = TeDRX = 5.12 seconds
- Case 3IDLE,LTE) TeDRX ≠ 512rf (=5.12 seconds) is configured, and a camp-
on cell allows eDRX.
  => Within a PTW, TDRX_IDLE,LTE = min (UE specific paging cycle, Default
paging cycle)
=> Outside a PTW, a UE may not monitor paging.
2. An RRC_INACTIVE UE may determine a paging monitoring cycle
(TDRX_INACTIVE,LTE) as shown below for each of the three cases (Case
1INACTIVE,LTE, 2INACTIVE,LTE, 3INACTIVE,LTE).
- Case 1INACTIVE,LTE) TeDRX is not configured, or a camp-on cell does not
allow eDRX.
  => TDRX_INACTIVE,LTE = min (UE specific paging cycle, Default paging
cycle, RAN paging cycle)
- Case 2INACTIVE,LTE) TeDRX = 512rf (=5.12 seconds) is configured, and a
camp-on cell allows eDRX.
  => TDRX_INACTIVE,LTE = min (TeDRX (=5.12 seconds), RAN paging
cycle)
- Case 3INACTIVE,LTE) TeDRX ≠ 512rf (=5.12 seconds) is configured, and a
camp-on cell allows eDRX.
  => Within a PTW, TDRX_INACTIVE,LTE = min (UE specific paging cycle,
Default paging cycle, RAN paging cycle)
  => Outside a PTW, TDRX_INACTIVE,LTE = RAN paging cycle
```

Determining a paging monitoring cycle (or DRX cycle) in LTE may be summarized as shown in Table 13 and Table 14 below.

TABLE 13
RRC_IDLE mode UE

| 1) T_{eDRX} is not | | |
|---|---|---|
| configured, or 2) | 1) T_{eDRX} = 5.12 s | 1) T_{eDRX} ≠ 5.12 s |
| eDRX-Allowed is | and 2) eDRX-Allowed | and 2) eDRX-Allowed |
| absent in SIB | is present in SIB | is present in SIB |
| min (UE specific, | T_{eDRX} = 5.12 s | During PTW, min |
| default) | | (UE specific, default) |
| | | Outside PTW, No monitoring |

TABLE 14
RRC_INACTIVE mode UE

| 1) T_{eDRX} is not | | |
|---|---|---|
| configured, or 2) | 1) T_{eDRX} = 5.12 s | 1) T_{eDRX} ≠ 5.12 s |
| eDRX-Allowed is | and 2) eDRX-Allowed | and 2) eDRX-Allowed |
| absent in SIB | is present in SIB | is present in SIB |
| min (UE specific, | min | During PTW, min |
| default, RAN) | (T_{eDRX}(=5.12 s), | (UE specific, |
| | RAN) | default, RAN) |
| | | Outside PTW, RAN |

In Release 17 NR, different from an eDRX configuration in LTE, an existing TeDRX may be classified as an eDRX cycle (=TeDRX_IDLE) for an RRC_IDLE UE and an eDRX cycle (=TeDRX_INACTIVE) for an RRC_INACTIVE UE. TeDRX_IDLE may be configured by a CN, and thus may also be expressed as TeDRX_CN. TeDRX_INACTIVE may be configured by a RAN (base station), and thus may also be expressed as TeDRX_RAN. In addition, in Release 17 NR, based on TeDRX_IDLE and TeDRX_INACTIVE configurations, and based on whether a camp-on cell supports eDRX (eDRX-AllowedIdle, eDRX-AllowedInactive) (e.g., operation 9-35), the paging monitoring cycles (DRX cycle) of an RRC_IDLE UE and an RRC_INACTIVE UE may be determined as shown in TABLE 15.

TABLE 15

| | |
|---|---|
| 1. | An RRC_IDLE UE may determine a paging monitoring cycle |

(TDRX_IDLE,NR) as shown below for each of the three cases (Case 1IDLE,NR,
2IDLE,NR, 3IDLE,NR).
* Note: min denotes a function of outputting the minimum value of only the
values configured for a UE among input values.
- Case 1IDLE,NR) TeDRX_IDLE is not configured.

| | |
|---|---|
| => | TDRX_IDLE,NR= min (UE specific paging cycle, Default paging cycle) |

- Case 2IDLE,NR) TeDRX_IDLE ≤ 10.24 seconds is configured.

| | |
|---|---|
| => | In the case in which eDRX-AllowedIdle is configured, TDRX_IDLE,NR = |

TeDRX_IDLE

| | |
|---|---|
| => | In the case in which eDRX-AllowedIdle is not configured, TDRX_IDLE,NR |

= min (UE specific paging cycle, Default paging cycle)
- Case 3IDLE,NR) TeDRX_IDLE > 10.24 seconds is configured.

| | |
|---|---|
| => | In the case in which eDRX-AllowedIdle is configured, |
| | => within PTW_IDLE, TDRX_IDLE,NR = min (UE specific paging |

cycle, Default paging cycle)

=> outside PTW_IDLE, a UE may not monitor paging.

*Note: In Release 17 NR, PTW_IDLE is only defined in case that TeDRX_IDLE
> 10.24 seconds is satisfied, and occurs at intervals of TeDRX_IDLE.

| | |
|---|---|
| 2. | An RRC_INACTIVE UE may determine a paging monitoring cycle |

(TDRX_INACTIVE,NR) for each of the five cases (Case 1INACTIVE,NR,
2INACTIVE,NR, 3INACTIVE,NR, 4INACTIVE,NR, 5INACTIVE,NR).

| | |
|---|---|
| - | Case 1INACTIVE, NR) TeDRX_IDLE is not configured, and |

TeDRX_INACTIVE is not configured either.

| | |
|---|---|
| => | TDRX_INACTIVE,NR = min (UE specific paging cycle, Default paging |

cycle, RAN paging cycle)
- Case 2INACTIVE,NR) TeDRX_IDLE ≤ 10.24 seconds is configured, and
TeDRX_INACTIVE is not configured.

| | |
|---|---|
| => | In the case in which eDRX-AllowedIdle is configured, |

TDRX_INACTIVE, NR = min (TeDRX_IDLE, RAN paging cycle).

| | |
|---|---|
| => | In the case in which eDRX-AllowedIdle is not configured, |

TDRX_INACTIVE,NR = min (UE specific paging cycle, Default paging cycle,
RAN paging cycle).
- Case 3INACTIVE,NR) TeDRX_IDLE ≤ 10.24 seconds is configured, and
TeDRX_INACTIVE ≤ 10.24 seconds is configured.

| | |
|---|---|
| => | In the case in which eDRX-AllowedIdle is configured and eDRX- |

AllowedInactive is configured, TDRX_INACTIVE,NR = min (TeDRX_IDLE,
TeDRX_INACTIVE).

| | |
|---|---|
| => | In the case in which eDRX-AllowedIdle is configured, and eDRX- |

AllowedInactive is not configured, TDRX_INACTIVE,NR = min
(TeDRX_IDLE, RAN paging cycle).

| | |
|---|---|
| => | In the case in which eDRX-AllowedIdle is not configured, and eDRX- |

AllowedInactive is not configured, TDRX_INACTIVE,NR = min (UE specific
paging cycle, Default paging cycle, RAN paging cycle).
- Case 4INACTIVE,NR) TeDRX_IDLE > 10.24 seconds is configured and,
TeDRX_INACTIVE is not configured.

| | |
|---|---|
| => | In the case in which eDRX-AllowedIdle is configured, |
| => | within a PTW, TDRX_INACTIVE,NR = min (UE specific paging cycle, |

Default paging cycle, RAN paging cycle)

| | |
|---|---|
| => | outside a PTW, TDRX_INACTIVE,NR = RAN paging cycle |
| => | In the case in which eDRX-AllowedIdle is not configured, |
| => | TDRX_INACTIVE,NR = min (UE specific paging cycle, Default paging |

cycle, RAN paging cycle)
- Case 5INACTIVE,NR) TeDRX_IDLE > 10.24 seconds is configured, and
TeDRX_INACTIVE ≤ 10.24 seconds is configured.

| | |
|---|---|
| => | In the case in which eDRX-AllowedIdle is configured, and eDRX- |

AllowedInactive is configured,

| | |
|---|---|
| => | within a PTW, TDRX_INACTIVE,NR = min (UE specific paging cycle, |

Default paging cycle, TeDRX_INACTIVE)

| | |
|---|---|
| => | outside a PTW, TDRX_INACTIVE,NR = TeDRX_INACTIVE |
| => | In the case in which eDRX-AllowedIdle is configured, and eDRX- |

AllowedInactive is not configured,

| | |
|---|---|
| => | within a PTW, TDRX_INACTIVE,NR = min (UE specific paging cycle, |

Default paging cycle, RAN paging cycle)

| | |
|---|---|
| => | outside a PTW, TDRX_INACTIVE,NR = RAN paging cycle |
| => | In the case in which eDRX-AllowedIdle is not configured, and eDRX- |

AllowedInactive is not configured, TDRX_INACTIVE,NR = min (UE specific
paging cycle, Default paging cycle, RAN paging cycle).

According to an embodiment, the case of TeDRX_INACTIVE>10.24 seconds may be supported/defined in order to reduce energy consumption by an inactive mode UE.

According to an embodiment, in a UE capability information message, an indicator for extended DRX in an RRC_INACTIVE mode which is longer than 10.24 seconds may be defined. For example, this may be defined as shown in Table 16 below.

TABLE 16

| | |
|---|---|
| extendedDRX-CycleInactive-long-r18 | ENUMERATED {supported} OPTIONAL, |

Through the above, a base station may determine whether a UE supports extended DRX in an RRC_INACTIVE mode which is longer than 10.24 seconds. In the case in which the UE supports extended DRX in the RRC_INACTIVE mode which is longer than 10.24 seconds, the UE may configure/include the corresponding indicator, upon receiving a UE capability enquiry. In the case in which the UE does not support extended DRX in the RRC_INACTIVE mode which is longer than 10.24 seconds, the UE may omit or may not include the corresponding indicator. According to an embodiment, the indicator may be defined in TS 38.306, as shown in Table 17 below.

TABLE 17

| | | | FDD- | FR1- |
|---|---|---|---|---|
| | | | TDD | FR2 |
| Definitions for parameters | Per | M | DIFF | DIFF |
| extendedDRX-CycleInactive-long-r18 | UE | No | No | No |
| Indicates whether UE supports the | | | | |
| extended DRX in RRC_INACTIVE | | | | |
| with values longer than 1024 | | | | |
| radio frames as specified in | | | | |
| TS 38.331. The UE may indicate | | | | |
| this field only if it supports | | | | |
| extended DRX in RRC_IDLE. | | | | |

According to an embodiment, the UE may support extended DRX in the RRC_INACTIVE mode which is longer than 10.24 seconds, but may not support extended DRX in the RRC_INACTIVE mode which is shorter than or equal to 10.24 seconds.

According to an embodiment, the indicator may be defined in TS 38.306, as shown in Table 18 below.

(Parentheses are omittable.)

TABLE 18

| | | | FDD- | FR1- |
|---|---|---|---|---|
| | | | TDD | FR2 |
| Definitions for parameters | Per | M | DIFF | DIFF |
| extendedDRX-CycleInactive-long-r18 | UE | No | No | No |
| Indicates whether UE supports the | | | | |
| extended DRX in RRC_INACTIVE | | | | |
| with values longer than 1024 | | | | |
| radio frames as specified in | | | | |
| TS 38.331. The UE may indicate | | | | |
| this field only if it supports | | | | |
| (both extended DRX in RRC_IDLE | | | | |
| and) extendedDRX-CycleInactive-r17. | | | | |

In this example, in consideration that the definition of extendedDRX-CycleInactive-r17 is as shown in Table 19 below,

TABLE 19

| | | | | |
|---|---|---|---|---|
| extendedDRX-CycleInactive-r17 | UE | No | No | No |
| Indicates whether UE supports the | | | | |
| extended DRX in RRC_INACTIVE with | | | | |
| values of 256, 512 and 1024 radio | | | | |
| frames as specified in TS 38.331. | | | | |
| The UE may indicate support for | | | | |
| extended DRX in RRC_INACTIVE only | | | | |
| if it supports extended DRX in RRC_IDLE. | | | | |

The UE may support extended DRX in the RRC_INACTIVE mode which is longer than 10.24 seconds only in case that the UE supports extended DRX in the RRC_INACTIVE mode that is shorter than or equal to 10.24 seconds.

According to an embodiment, the indicator may be defined in TS 38.306, as shown in Table 20 below.

TABLE 20

| | | | FDD- | FR1- |
|---|---|---|---|---|
| | | | TDD | FR2 |
| Definitions for parameters | Per | M | DIFF | DIFF |
| extendedDRX-CycleInactive-long-r18 | UE | No | No | No |
| Indicates whether UE supports the | | | | |
| extended DRX in RRC_INACTIVE | | | | |
| with values longer than 1024 | | | | |
| radio frames as specified | | | | |
| in TS 38.331. | | | | |

According to an embodiment, the UE may support extended DRX in the RRC_INACTIVE mode which is longer than 10.24 seconds, irrespective of whether the UE supports extended DRX in the RRC_INACTIVE mode which is shorter than or equal to 10.24 seconds and whether the UE supports extended DRX in the RRC_IDLE mode.

According to an embodiment, in Release 17 NR, an eDRX allow indicator included in system information (e.g., SIB1) may be as shown in Table 21 below.

TABLE 21

| | |
|---|---|
| eDRX-AllowedIdle-r17 ENUMERATED {true} | OPTIONAL, -- Need R |
| eDRX-AllowedInactive-r17 ENUMERATED {true} | OPTIONAL, -- Cond EDRX- |

RC
eDRX-AllowedIdle
The presence of this field indicates that extended DRX for CN paging is allowed in the
cell for UEs in RRC_IDLE or RRC_INACTIVE. The UE may stop using extended
DRX for CN paging in RRC_IDLE or RRC_INACTIVE if eDRX-AllowedIdle is not
present.
eDRX-AllowedInactive
The presence of this field indicates that extended DRX for RAN paging is allowed in
the cell for UEs in RRC_INACTIVE. The UE may stop using extended DRX for RAN
paging in RRC_INACTIVE if eDRX-AllowedInactive is not present.

| | |
|---|---|
| EDRX-RC | The field is optionally present, Need R, in a cell that |
| | enables eDRX-AllowedIdle, otherwise it is absent. |

According to an embodiment of the disclosure, an indicator indicating whether the base station allows or does not allow extended DRX in the RRC_INACTIVE mode which is longer than 10.24 seconds may be defined/included in system information (e.g., SIB1) as shown in Table 22 below.

TABLE 22

| | |
|---|---|
| eDRX-AllowedIdle-r17 ENUMERATED {true} | OPTIONAL, -- Need R |
| eDRX-AllowedInactive-r17 ENUMERATED {true} | OPTIONAL, -- Cond |
| EDRX-RC | |
| eDRX-AllowedInactive-long-r18 ENUMERATED {true} | OPTIONAL, -- |
| Cond EDRX-RC-LONG | |

eDRX-AllowedIdle
The presence of this field indicates that extended DRX for CN paging is allowed in
the cell for UEs in RRC_IDLE or RRC_INACTIVE. The UE may stop using extended
DRX for CN paging in RRC_IDLE or RRC_INACTIVE if eDRX-AllowedIdle is not
present.
eDRX-AllowedInactive
The presence of this field indicates that extended DRX for RAN paging not longer
than 10.24s is allowed in the cell for UEs in RRC_INACTIVE. The UE may stop
using extended DRX for RAN paging not longer than 10.24s in RRC_INACTIVE if
eDRX-AllowedInactive is not present.
eDRX-AllowedInactive-long
The presence of this field indicates that extended DRX for RAN paging longer than
10.24s is allowed in the cell for UEs in RRC_INACTIVE. The UE may stop using
extended DRX for RAN paging longer than 10.24s in RRC_INACTIVE if eDRX-
AllowedInactive-long is not present.

| | |
|---|---|
| EDRX- | The field is optionally present, Need R, in a cell that enables eDRX- |
| RC | AllowedIdle, otherwise it is absent. |

According to an embodiment of the disclosure, a condition for including an indicator, which is used by the base station to allow or not to allow extended DRX in the RRC_INACTIVE mode which is longer than 10.24 seconds, may be defined as shown in Table 23 below.

TABLE 23

| | |
|---|---|
| EDRX-RC- | The field is optionally present, Need R, in |
| LONG | a cell that enables eDRX-AllowedIdle, |
| | otherwise it is absent. |

According to an embodiment, the base station may allow extended DRX in the RRC_INACTIVE mode which is longer than 10.24 seconds only in case that it allows extended DRX in the RRC_IDLE mode.

According to an embodiment of the disclosure, a condition for including an indicator used by the base station to allow or not to allow extended DRX in the RRC_INACTIVE mode which is longer than 10.24 seconds may be defined as shown in Table 24 below. (Parentheses are omittable.)

TABLE 24

| | |
|---|---|
| EDRX-RC- | The field is optionally present, Need R, in |
| LONG | a cell that enables (both eDRX-AllowedIdle |
| | and) eDRX-AllowedInactive, otherwise |
| | it is absent. |

According to an embodiment, the base station may allow extended DRX in the RRC_INACTIVE mode which is longer than 10.24 seconds only in case that it allows extended DRX in RRC_IDLE mode that is shorter than or equal to 10.24 seconds.

According to an embodiment, a condition for including an indicator used by the base station to allow or not to allow extended DRX in the RRC_INACTIVE mode which is longer than 10.24 seconds may be Need R (e.g., without defining EDRX-RC-LONG).

According to an embodiment, in order to configure extended DRX in the RRC_INACTIVE mode which is longer than 10.24 seconds, an eDRX cycle and a PTW length may be defined in an RRC Release message (in SuspendConfig) as shown in Table 25 below.

TABLE 25

| ran-ExtendedPagingCycle-r17 | ExtendedPagingCycle-r17 | OPTIONAL - |
|---|---|---|
| - Cond RANPaging | | |
| ran-ExtendedPagingCycle-long-r18 | ExtendedPagingCycle-long-r18 | OPTIONAL -- |

Cond RANPaging-long

| | | | |
|---|---|---|---|
| ran-PagingTimeWindow-r18 | ENUMERATED | {ms1280, | ms2560, |

ms3840, ... , ms 39680, ms40960} OPTIONAL -- Cond RANPaging-long

SuspendConfig field descriptions
ran-ExtendedPagingCycle
The extended DRX (eDRX) cycle not longer than 10.24s for RAN-initiated paging to be applied
by the UE. Value rf256 corresponds to 256 radio frames, value rf512 corresponds to 512 radio
frames and so on. Value of the field indicates an eDRX cycle which is shorter or equal to the
IDLE mode eDRX cycle configured for the UE.
ran-ExtendedPagingCycle-long
The extended DRX (eDRX) cycle longer than 10.24s for RAN-initiated paging to be applied by
the UE. Value rf2048 corresponds to 2048 radio frames, value rf4096 corresponds to 4096 radio
frames and so on. Value of the field indicates an eDRX cycle which is shorter or equal to the
IDLE mode eDRX cycle configured for the UE.

According to an embodiment of the disclosure, the base station may configure an extended DRX cycle (e.g., ran-ExtendedPagingCycle-r17) in the RRC_INACTIVE mode, which is shorter than or equal to 10.24 seconds, only in case that the base station does not configure an extended DRX cycle (e.g., ran-ExtendedPagingCycle-long-r18) in the RRC_INACTIVE mode which is longer than 10.24 seconds. Since cycles are configured redundantly, the UE may mix up operations.

TABLE 26

| | |
|---|---|
| RANPaging | This field is optionally present, Need R, if |
| | the UE is configured with eDRX in IDLE mode, |
| | see TS 24.501 and if ran-ExtendedPagingCycle- |
| | long is not present; otherwise, the field |
| | is not present. |

According to an embodiment of the disclosure, the base station may configure an extended DRX cycle (e.g., ran-ExtendedPagingCycle-long-r18) in the RRC_INACTIVE mode, which is longer than 10.24 seconds, only in case that the base station does not configure an extended DRX cycle (e.g., ran-ExtendedPagingCycle-r17) in the RRC_INACTIVE mode which is shorter than or equal to 10.24 seconds. Since cycles are configured redundantly, the UE may mix up operations.

In addition, the base station may configure an extended DRX cycle (ran-ExtendedPagingCycle-long-r18)) in the RRC_INACTIVE mode, which is longer than 10.24 seconds, only in case that eDRX in the RRC_IDLE mode is configured for the UE. eDRX in the RRC_IDLE mode needs to be preferentially considered in order to save energy of the UE. A UE that is not configured with eDRX may not consider saving energy important.

TABLE 27

| | |
|---|---|
| RANPaging- | This field is optionally present, Need R, if |
| long | the UE is configured with eDRX in IDLE mode, |
| | see TS 24.501 and if ran-ExtendedPagingCycle |
| | is not present; otherwise, the field |
| | is not present. |

According to an embodiment, the base station may configure an extended DRX cycle (e.g., ran-ExtendedPagingCycle-long-r18) in the RRC_INACTIVE mode, which is longer than 10.24 seconds, only in case that the base station does not configure an extended DRX cycle (e.g., ran-ExtendedPagingCycle-r17) in the RRC_INACTIVE mode which is shorter than or equal to 10.24 seconds. Since cycles are configured redundantly, the UE may mix up operations.

TABLE 28

| | |
|---|---|
| RANPaging- | This field is optionally present, Need R, if |
| long | ran-ExtendedPagingCycle is not present; |
| | otherwise, the field is not present. |

According to an embodiment, in the case of performing RAN paging (FIG. 8), in case that a serving base station transmits a RAN paging message to another base station in an XnAP interface in operation 8-15, a configuration of eDRX (extended DRX) information in the RRC_INACTIVE mode which is longer than or equal to 10.24 seconds may be included. In the configuration, the cycle (TeDRX, INACTIVE, TeDRX,RAN, TeDRX_RAN, or TeDRX_RAN) of eDRX (extended DRX) in the RRC_INACTIVE mode which is longer than or equal to 10.24 seconds, and the length of a PTW (RAN configured PTW, PTW_RAN, or PTW_INACTIVE) of eDRX in the RRC_INACTIVE mode may be defined/included. According to an embodiment of the disclosure, an IE as shown in Table 29 below may be defined. The base station that receives the information may calculate a paging monitoring cycle or paging occasion associated with the UE, and may perform paging with respect to the UE according to the calculation in operations 8-20 and 8-25.

TABLE 29
9.2.3.162 NR Paging eDRX Information for RRC INACTIVE
This IE indicates the NR Paging eDRX parameters for
RRC_INACTIVE as defined in TS 38.304.

| | | | | |
|---|---|---|---|---|
| | | | IE type and | |
| IE/Group Name | Presence | Range | reference | Semantics description |

| | | | |
|---|---|---|---|
| NR Paging eDRX | M | ENUMERATED | T_{eDRX, RAN} defined in TS |
| Cycle Inactive | | (hfquarter, hfhalf, | 38.304 [33]. Unit: [number |
| | | hf1, hf2, hf4, hf8, | of hyperframes] |
| | | hf16, hf32, hf64, | |
| | | hf128, hf256, | |
| | | hf512, hf1024) | |
| NR Paging Time | O | ENUMERATED | RAN configured PTW |
| Window Inactive | | (s1, s2, s3, s4, s5, | defined in TS 38.304. |
| | | s6, s7, s8, s9, s10, | Unit: [1.28 seconds] |
| | | s11, s12, s13, s14, | |
| | | s15, s16, . . . , s17, | |
| | | s18, s19, s20, s21, | |
| | | s22, s23, s24, s25, | |
| | | s26, s27, s28, s29, | |
| | | s30, s31, s32) | |

According to an embodiment, an eRedCap UE is limited to have a lower cost or capability than the existing RedCap UE, and thus an indicator (e.g., support-eRedCap-r18) indicating whether a corresponding UE is an eRedCap UE or supports eRedCap may be defined in a UE capability information message transmitted by the UE so that the base station distinguishes an eRedCap UE in case that providing a service (e.g., more robust resource allocation). According to an embodiment, upon reception of a UE capability enquiry message, the UE, if the UE is an eRedCap UE or supports eRedCap, may include the corresponding indicator in the UE capability information message or set a corresponding value to true, and may transmit the message to the base station. If the UE is not an eRedCap UE or does not support eRedCap, the UE may omit the corresponding indicator in the UE capability information message, or may indicate a corresponding value as false. According to an embodiment, in the case in which the UE supports all or some of the following capabilities, it is defined that the UE is an eRedCap UE or supports eRedCap:
Max 5 MHz BB (Baseband) bandwidth only for PDSCH (for both unicast and broadcast) and PUSCH;
Max 20 MHz RF bandwidth for UL and DL;
eDRX in RRC_INACTIVE (>10.24 s);
eRedCap early indication based on Msg1;
eRedCap early indication based on MsgA;
eRedCap early indication based on Msg3;
eRedCap specific UL BWP; and/or
eRedCap specific UL BWP.

According to an embodiment, whether the UE supports one or some of the capabilities may be reported to the base station via a UE capability information message (separately from support-eRedCap-r18).

According to an embodiment, the base station may indicate whether the base station supports or allows one or some of the capabilities to the UE, and, in this instance, an SIB may be used.

According to an embodiment of the disclosure, whether the following UE capability (existing RedCap UE capability) is supported may be equally applied to an eRedCap UE, and thus definitions as shown in Table 30 may be made.

TABLE 30

| | | | |
|---|---|---|---|
| supportOf16DRB-RedCap-r17 | UE | No | No |
| Indicates whether the RedCap or eRedCap UE | | | |
| supports 16 DRBs. This capability is only | | | |
| applicable for RedCap or eRedCap UEs. | | | |
| longSN-RedCap-r17 | UE | No | No |
| Indicates whether the RedCap or eRedCap UE | | | |
| supports 18 bit length of PDCP sequence | | | |
| number. This capability is only applicable | | | |
| for RedCap or eRedCap UEs. | | | |
| am-WithLongSN-RedCap-r17 | UE | No | No |
| Indicates whether the RedCap or eRedCap UE | | | |
| supports AM DRB with 18 bit length of RLC | | | |
| sequence number. This capability is only | | | |
| applicable for RedCap or eRedCap UEs. | | | |

| | | | | |
|---|---|---|---|---|
| bwp-WithoutCD-SSB-OrNCD-SSB-RedCap-r17 | Band | No | N/A | N/A |
| Indicates support of RRC-configured DL BWP | | | | |
| without CD-SSB or NCD-SSB. The UE can | | | | |
| include this field only if the UE supports | | | | |
| supportOfRedCap-r17 or support-eRedCap-r18. | | | | |
| halfDuplexFDD-TypeA-RedCap-r17 | Band | No | FDD | FR1 |
| Indicates support of Half-duplex FDD | | | only | only |
| operation (instead of full-duplex FDD | | | | |
| operation) type A for RedCap UE. The UE | | | | |
| can include this field only if the UE | | | | |
| supports supportOfRedCap-r17 or | | | | |
| support-eRedCap-r18. | | | | |

Rel-17 relaxed measurement for RRC_IDLE/RRC_INACTIVE
It is optional for RedCap or eRedCap UE to support
Rel-17 relaxed RRM measurements of neighbour cells in
RRC_IDLE/RRC_INACTIVE as specified in TS 38.304 [21].

According to an embodiment, as a UE capability constraint, definitions as shown in Table 31 may be made.

TABLE 31

| Parameter | Description | Value |
|---|---|---|
| #DRBs | The number of DRBs that | 8 per UE, for RedCap or |
| | a UE may support. | eRedCap UEs. |
| | | 16 per UE, otherwise. |
| | | NOTE 1 |
| | | NOTE 3 |
| | | NOTE 4 |

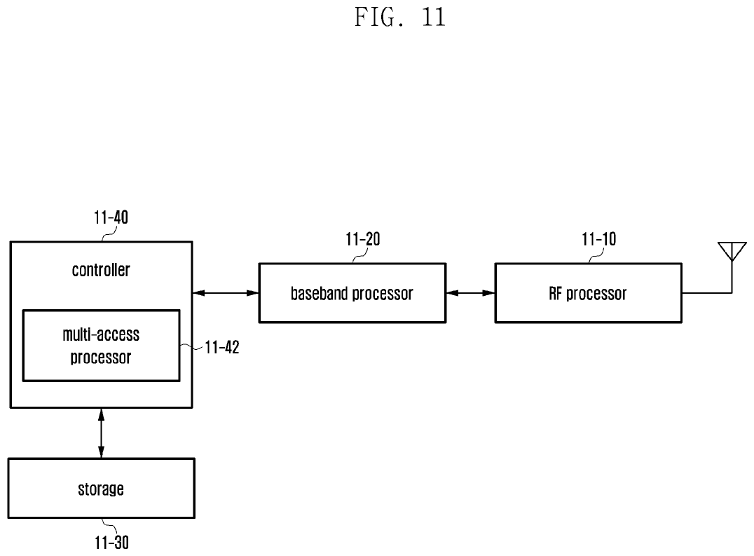

FIG. 11 illustrates a UE device according to an embodiment of the present disclosure.

Referring to FIG. 11, the UE may include a radio frequency (RF) processor 11-10, a baseband processor 11-20, a storage 11-30, and a controller 11-40. The configuration of the UE is not limited to the example illustrated in FIG. 11 and may include fewer or more component elements than the configuration of FIG. 11.

The RF processor 11-10 may perform functions in order to transmit or receive a signal via a wireless channel, such as band conversion or amplification of a signal, or the like. That is, the RF processor 11-10 up-converts a baseband signal provided from the baseband processor 11-20 into an RF band signal, transmits the RF band signal via an antenna, and down-converts an RF band signal received via the antenna into a baseband signal. For example, the RF processor 11-10 may include a transmission filter, a reception filter, an amplifier, a mixer, an oscillator, a digital-to-analog converter (DAC), an analog-to-digital converter (ADC), and the like, but is not limited to the example. Although FIG. 11 illustrates only a single antenna, the UE may have a plurality of antennas. In addition, the RF processor 11-10 may include a plurality of RF chains. Furthermore, the RF processor 11-10 may perform beamforming. For the beamforming, the RF processor 11-10 may adjust the phase and the size of each signal transmitted or received via a plurality of antennas or antenna elements. In addition, the RF processor 11-10 may perform MIMO, and may receive multiple layers in case that performing a MIMO operation.

The baseband processor 11-20 may perform a function of converting between a baseband signal and a bitstream according to the physical layer standard of a system. For example, in the case of data transmission, the baseband processor 11-20 may encode and modulate a transmission bitstream, so as to produce complex symbols. In addition, in the case of data reception, the baseband processor 11-20, may restore a reception bitstream by demodulating and decoding a baseband signal provided from the RF processor 11-10. For example, according to an orthogonal frequency division multiplexing (OFDM) scheme, in the case of data transmission, the baseband processor 11-20 may produce complex symbols by encoding and modulating a transmission bitstream, may map the produced complex symbols to subcarriers, and then may perform an inverse fast Fourier transform (IFFT) operation and cyclic prefix (CP) insertion, thereby configuring OFDM symbols. In addition, in the case of data reception, the baseband processor 11-20 may divide a baseband signal provided from the RF processor 11-10 in units of OFDM symbols, may reconstruct signals mapped to subcarriers via fast Fourier transform (FFT), and then may reconstruct a received bitstream via demodulation and decoding.

The baseband processor 11-20 and the RF processor 11-10 may transmit or receive signals as described above. Accordingly, the baseband processor 11-20 and the RF processor 11-10 may be referred to as a transmitter, a receiver, a transceiver, or a communication circuit. Furthermore, at least one of the baseband processor 11-20 and the RF processor 11-10 may include a plurality of communication modules in order to support a plurality of different radio access technologies. In addition, at least one of the baseband processor 11-20 and the RF processor 11-10 may include different communication modules to process signals of different frequency bands. For example, the different radio access technologies may include a wireless LAN (e.g., IEEE 802.11), a cellular network (e.g., LTE), and the like. In addition, different frequency bands may include a super high frequency band (e.g., 2.NRHz, NRhz) and millimeter (mm) wave band (e.g., 60 GHz). The UE may perform signal transmission or reception with a base station using the baseband processor 11-20 and the RF processor 11-10, and a signal may include control information and data.

The storage 11-30 may store data, such as a basic program, an application program, configuration information, and the like for operating the UE. The storage 11-30 may store data information such as a basic program, an application program, and configuration information, and the like for operation of the UE. In addition, the storage 11-30 may provide data stored therein in response to a request from the controller 11-40.

The storage 11-30 may be embodied as a storage medium such as a ROM, a RAM, a hard disk, a CD-ROM, a DVD, and the like, or a combination of storage media. In addition, the storage 11-30 may include a plurality of memories. According to an embodiment of the disclosure, the storage 11-30 may store a program for performing a handover method according to the disclosure.

The controller 11-40 may control the overall operations of the UE. For example, the controller 11-40 may perform transmission or reception of a signal via the baseband processor 11-20 and the RF processor 11-10.

In addition, the controller 11-40 may record and read data in the storage 11-30. To this end, the controller 11-40 may include at least one processor. For example, the controller 11-40 may include a communication processor (CP) that performs control for communication, and an application processor (AP) that controls a higher layer such as an application program or the like. In addition, according to an embodiment of the disclosure, the controller 11-40 may include a multi-access processor 11-42 configured to process a process that operates in a multi-access mode. In addition, at least one configuration included in the UE may be embodied as a single chip.

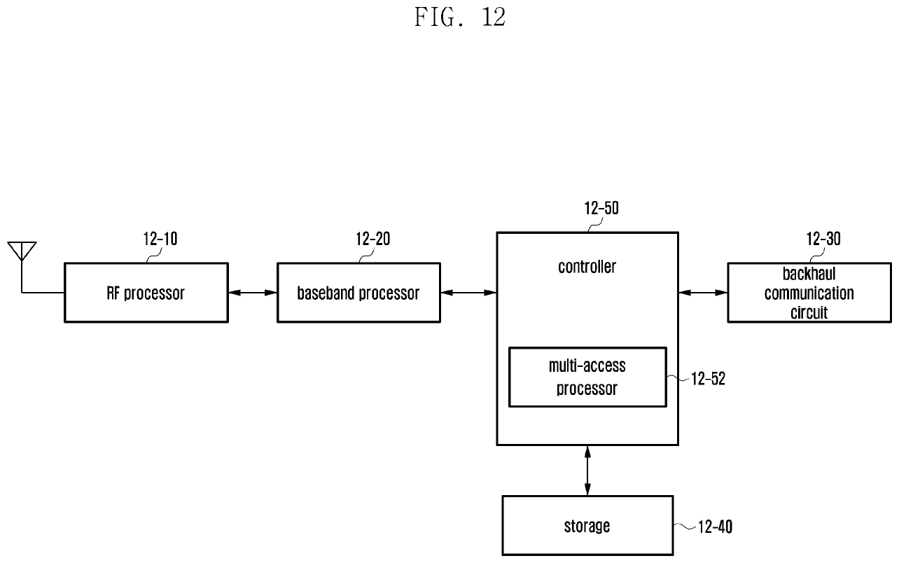

FIG. 12 illustrates a base station device according to an embodiment of the present disclosure.

The base station of FIG. 12 may be included in the network described above.

As illustrated in FIG. 12, the base station may include an RF processor 12-10, a baseband processor 12-20, a backhaul communication circuit 12-30, a storage 12-40, and a controller 12-50. The configuration of the base station is not limited to the example of FIG. 12, and may include fewer or more component elements than the configuration of FIG. 12. The RF processor 12-10 may perform functions in order to transmit or receive a signal via a wireless channel, such as band conversion or amplification of a signal, or the like. For example, the RF processor 12-10 may up-convert a baseband signal provided from the baseband processor 12-20 into an RF band signal, may transmit the RF band signal via an antenna, and may down-convert an RF band signal received via an antenna into a baseband signal. For example, the RF processor 12-10 may include a transmission filter, a reception filter, an amplifier, a mixer, an oscillator, a DAC, an ADC, and the like. Although FIG. 12 illustrates a single antenna, the RF processor 12-10 may include a plurality of antennas. In addition, the RF processor 12-10 may include a plurality of RF chains. Furthermore, the RF processor 12-10 may perform beamforming. For the beamforming, the RF processor 12-10 may adjust the phase and the size of each signal transmitted or received via a plurality of antennas or antenna elements. The RF processor 12-10 may perform a downlink MIMO operation by transmitting one or more layers.

The baseband processor 12-20 may perform a function of converting between a baseband signal and a bitstream according to the physical layer standard of a system. For example, in the case of data transmission, the baseband processor 12-20 may encode and modulate a transmission bitstream, so as to produce complex symbols. In addition, in the case of data reception, the baseband processor 12-20 may restore a reception bitstream by demodulating and decoding a baseband signal provided from the RF processor 12-10. For example, according to an OFDM scheme, in the case of data transmission, the baseband processor 12-20 may produce complex symbols by encoding and modulating a transmission bitstream, may map the produced complex symbols onto subcarriers, and then may perform an IFFT operation and CP insertion, thereby configuring OFDM symbols. In addition, in the case of data reception, the baseband processor 12-20 may divide a baseband signal provided from the RF processor 12-10 in units of OFDM symbols, may reconstruct the signals mapped to the subcarriers via a fast Fourier transform (FFT) operation, and then may reconstruct a received bitstream via demodulation and decoding. The baseband processor 12-20 and the RF processor 12-10 may transmit or receive signals as described above. Accordingly, the baseband processor 12-20 and the RF processor 12-10 may be referred to as a transmitter, a receiver, a transceiver, a communication circuit, or a wireless communication circuit. The base station may perform signal transmission or reception with a UE using the baseband processor 12-20 and the RF processor 12-10, and the signal may include control information and data.

The backhaul communication circuit 12-30 may provide an interface for performing communication with other nodes in a network. For example, the backhaul communication circuit 12-30 may convert, into a physical signal, a bitstream transmitted from a primary base station to another node, for example, a secondary base station, a core network, or the like, and may convert a physical signal received from the other node into a bitstream.

The storage 12-40 may store data such as a basic program, an application program, and configuration information for operation of the primary base station. For example, the storage 12-40 may store information associated with a bearer allocated to a connected UE, a measurement result reported from a connected UE, and the like. In addition, the storage 12-40 may store information which is a criterion for determining whether to provide multiple accesses to a UE or to stop providing the same. In addition, the storage 12-40 may provide data stored therein in response to a request from the controller 12-50. The storage 12-40 may be embodied as a storage medium such as a ROM, a RAM, a hard disk, a CD-ROM, a DVD, and the like, or a combination of storage media. In addition, the storage 12-40 may include a plurality of memories. According to an embodiment of the disclosure, the storage 12-40 may store a program for performing handover according to the disclosure.

The controller 12-50 may control overall operations of the primary base station. For example, the controller 12-50 may transmit or receive a signal via a baseband processor 12-20, an RF processor 12-10, or a backhaul communication circuit 12-30. In addition, the controller 12-50 may record and read data in the storage 12-40. To this end, the controller 12-50 may include at least one processor. In addition, according to an embodiment of the disclosure, the controller 12-50 may include a multi-access processor 12-52 configured to process a process that operates in a multi-access mode.

Methods disclosed in the claims and/or methods according to the embodiments described in the specification of the disclosure may be implemented by hardware, software, or a combination of hardware and software.

In case that the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein.

The programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. Furthermore, a plurality of such memories may be included in the electronic device.

In addition, the programs may be stored in an attachable storage device which may access the electronic device through communication networks such as the Internet, Intranet, Local Area Network (LAN), Wide LAN (WLAN), and Storage Area Network (SAN) or a combination thereof. Such a storage device may access the electronic device via an external port. Furthermore, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof. That is, it will be apparent to those skilled in the art that other variants based on the technical idea of the disclosure may be implemented. Furthermore, the above respective embodiments may be employed in combination, as necessary. For example, the method provided in the disclosure may be partially combined to operate a base station and a terminal. Furthermore, although embodiments of the disclosure have been described on the basis of 5G and NR systems, other variants based on the technical idea of the embodiments may be implemented in other systems such as LTE, LTE-A, or LTE-A-Pro systems.

The embodiments of the disclosure described and shown in the specification and the drawings are merely specific examples that have been presented to easily explain the technical contents of embodiments of the disclosure and help understanding of embodiments of the disclosure, and are not intended to limit the scope of embodiments of the disclosure. It will be apparent to those skilled in the art that, in addition to the embodiments set forth herein, other variants based on the technical idea of the disclosure may be implemented.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a user equipment (UE) in a wireless communication system, the method comprising:
receiving, from a base station, a UE capability request message;
transmitting, to the base station, a UE capability message including first information indicating support of an extended discontinuous reception (eDRX) in a radio resource control (RRC) inactive, wherein a cycle of the eDRX is longer than 10.24 seconds;
receiving, from the base station, an RRC release message including paging information identified based on the first information indicating support of the eDRX; and
performing, based on the paging information included in the RRC release message, a paging monitoring operation in the RRC inactive.

2. The method of claim 1, further comprising obtaining system information including second information that indicates whether the eDRX is allowed in the RRC inactive,
wherein whether to use the eDRX is identified based on the second information.

3. The method of claim 2, wherein the first information is supported in case that the UE supports the eDRX in an RRC idle, and
wherein the second information is supported in case that the base station supports the eDRX in the RRC idle.

4. The method of claim 1, wherein a radio access network (RAN) paging message including the paging information is transmitted to another base station from the base station,
wherein the RAN paging message includes configuration information for the eDRX, and
wherein the configuration information includes information on the cycle of the eDRX that is longer than 10.24 seconds and information on paging time window (PTW).

5. The method of claim 2, wherein the UE capability message includes third information indicating supporting of the eDRX in an RRC idle, and
wherein the system information includes fourth information indicating allowing of the eDRX in the RRC idle.

6. A method performed by a base station in a wireless communication system, the method comprising:
transmitting, to a user equipment (UE), a UE capability request message;
receiving, from the UE, a UE capability message including first information indicating support of an extended discontinuous reception (eDRX) in a radio resource control (RRC) inactive, wherein a cycle of the eDRX is longer than 10.24 seconds; and
transmitting, to the UE, an RRC release message including paging information identified based on the first information indicating support of the eDRX,
wherein, based on the paging information included in the RRC release message, a paging monitoring operation is performed in the RRC inactive.

7. The method of claim 6, further comprising transmitting system information including second information indicating whether the eDRX is allowed in the RRC inactive, and
wherein whether to use the eDRX is identified based on the second information.

8. The method of claim 7, wherein the first information is supported in case that the UE supports the eDRX in an RRC idle, and
wherein the second information is supported in case that the base station supports the eDRX in the RRC idle.

9. The method of claim 6, wherein a radio access network (RAN) paging message including the paging information is transmitted to another base station from the base station,
wherein the RAN paging message includes configuration information for the eDRX, and
wherein the configuration information includes information on the cycle of the eDRX that is longer than 10.24 seconds and information on paging time window (PTW).

10. The method of claim 7, wherein the UE capability message includes third information indicating supporting of the eDRX in an RRC idle, and
wherein the system information includes fourth information indicating allowing of the eDRX in the RRC idle.

11. A user equipment (UE) in a wireless communication system, the UE comprising:
a transceiver; and
a controller operably coupled to the transceiver, the controller configured to:
receive, from a base station, a UE capability request message,
transmit, to the base station, a UE capability message including first information indicating support of an extended discontinuous reception (eDRX) in a radio resource control (RRC) inactive, wherein a cycle of the eDRX is longer than 10.24 seconds,
receive, from the base station, an RRC release message including paging information identified based on the first information indicating support of the eDRX, and
perform, based on the paging information included in the RRC release message, a paging monitoring operation in the RRC inactive.

12. The UE of claim 11, wherein the controller is configured to obtain system information including second information that indicates whether the eDRX is allowed in the RRC inactive, and
wherein whether to use the eDRX is identified based on the second information.

13. The UE of claim 12, wherein the first information is supported in case that the UE supports the eDRX an in RRC idle, and
wherein the second information is supported in case that the base station supports the eDRX in the RRC idle.

14. The UE of claim 11, wherein a radio access network (RAN) paging message including the paging information is transmitted to another base station from the base station,
wherein the RAN paging message includes configuration information for the eDRX, and
wherein the configuration information includes information on the cycle of the eDRX that is longer than 10.24 seconds and information on paging time window (PTW).

15. The UE of claim 12, wherein the UE capability message includes third information indicating supporting of the eDRX in an RRC idle, and
wherein the system information includes fourth information indicating allowing of the eDRX in the RRC idle.

16. A base station in a wireless communication system, the base station comprising:
a transceiver; and
a controller operably coupled to the transceiver, the controller configured to:
transmit, to a user equipment (UE), a UE capability request message,
receive, from the UE, a UE capability message including first information indicating support of an extended discontinuous reception (eDRX) in a radio resource control (RRC) inactive, wherein a cycle of the eDRX is longer than 10.24 seconds, and
transmit, to the UE, an RRC release message including paging information identified based on the first information indicating support of the eDRX,
wherein, based on the paging information included in the RRC release message, a paging monitoring operation is performed in the RRC inactive.

17. The base station of claim 16, wherein the controller is further configured to transmit system information including second information indicating whether the eDRX in the RRC inactive, and
wherein whether to use the eDRX is identified based on the second information.

18. The base station of claim 17, wherein the first information is supported in case that the UE supports the eDRX in an RRC idle, and
wherein the second information is supported in case that the base station supports the eDRX in the RRC idle.

19. The base station of claim 16, wherein a radio access network (RAN) paging message including the paging information is transmitted to another base station from the base station,
wherein the RAN paging message includes configuration information for the eDRX, and
wherein the configuration information includes information on the cycle of the eDRX that is longer than 10.24 seconds and information on paging time window (PTW).

20. The base station of claim 17, wherein the UE capability message includes third information indicating supporting of the eDRX in an RRC idle, and
wherein the system information includes fourth information indicating allowing of the eDRX in the RRC idle.
